(19) United States
(12) Patent Application Publication
(10) Pub. No.: US 2015/0104741 A1
(43) Pub. Date: Apr. 16, 2015

(54) TONER ADDITIVES FOR TUNABLE GLOSS

(71) Applicant: XEROX CORPORATION, Norwalk, CT (US)

(72) Inventors: VALERIE M. FARRUGIA, Oakville (CA); Kimberly D. Nosella, Mississauga (CA); Jordan Wosnick, Toronto (CA); Michael J. D'Amato, Thornhill (CA); Edward G. Zwartz, Mississauga (CA)

(73) Assignee: XEROX CORPORATION, Norwalk, CT (US)

(21) Appl. No.: 14/051,381

(22) Filed: Oct. 10, 2013

(51) Int. Cl. G03G 9/093

(52) U.S. Cl. CPC G03G 9/09364
USPC 430/108.1

(57) ABSTRACT

Toner additives for imparting certain properties to printed images. In particular, toner additives that provide desired tunable gloss levels. The present toner additives comprise polyolefins. The incorporation of such additives into toners, in particular, emulsion aggregation (EA) toners, have provided gloss control without any significant adverse impact on the minimum fix properties of the toner.

### BACKGROUND

The present disclosure relates to toners and processes useful in providing toners suitable for electrophotographic apparatuses, including apparatuses such as digital, image-on-image, and similar apparatuses. In particular, the disclosure relates to toner additives, namely, toner additives that provide desired tunable gloss levels. The present toner additives comprise polyolefins. The incorporation of such additives into toners, in particular, emulsion aggregation (EA) toners, have provided gloss control without any significant adverse impact on the minimum fix properties of the toner.

Numerous processes are within the purview of those skilled in the art for the preparation of toners. Emulsion aggregation is one such method. These toners are within the purview of those skilled in the art and toners may be formed by aggregating a colorant with a latex polymer formed by emulsion polymerization. For example, U.S. Pat. No. 5,853,943, the disclosure of which is hereby incorporated by reference in its entirety, is directed to a semi-continuous emulsion polymerization process for preparing a latex by first forming a seed polymer. Other examples of emulsion/aggregation/coalescing processes for the preparation of toners are illustrated in U.S. Pat. Nos. 5,403,693, 5,418,108, 5,364,729, and 5,346,797, the disclosures of each of which are hereby incorporated by reference in their entirety. Other processes are disclosed in U.S. Pat. Nos. 5,527,658, 5,585,215, 5,650,255, 5,650,256 and 5,501,935, the disclosures of each of which are hereby incorporated by reference in their entirety.

In general, toners comprise at least a binder resin, a colorant and one or more additives, including external surface additives. Any resin binder suitable for use in toner preparation may be employed without limitation. The properties of a toner are influenced by the materials and amounts of the materials of the toner.

Electrophotography, which is a method for visualizing image information by forming an electrostatic latent image, is currently employed in various fields. The term “electrostatographic” is generally used interchangeably with the term “electrophotographic.” In general, electrophotography comprises the formation of an electrostatic latent image on a photoreceptor, followed by development of the image with a developer containing a toner, and subsequent transfer of the image onto a transfer material such as paper or a sheet, and fixing the image on the transfer material by utilizing heat, a solvent, pressure and/or the like to obtain a permanent image.

Gloss levels of a printed document can be hardware controlled through the adjustment of the fuser speed and/or fuser roll temperature. This approach, however, has limitations. For example, lower speeds reduce productivity, while increasing fuser roll temperature reduces fuser roll life. In addition, there is a risk of poor adhesion of toner to the paper (e.g., while printing matte at lower temperatures and faster speeds) or toner adhering to the fuser roll (e.g., while printing glossy at higher temperatures and lower speeds). Improved methods for producing toners which are suitable for use in creating documents of varying gloss levels thus remain desirable.

### SUMMARY

The present embodiments provide a toner composition comprising a toner composition comprising: toner particles having a core, wherein the core comprises a resin, a colorant, a wax, and one or more additives incorporated into the core, the one or more additives comprising a polyolefin.

In specific embodiments, there is provided a toner composition comprising: a toner composition comprising: toner particles having a core, wherein the core comprises a styrene acrylate resin, a colorant, a wax, and one or more additives incorporated into the core, the one or more additives comprising poly(octadecene).

In yet other embodiments, there is provided a developer comprising: a developer comprising a toner composition; and a toner carrier, wherein the toner composition comprises toner particles having a core, wherein the core comprises a resin, a colorant, a wax, and one or more additives incorporated into the core, the one or more additives comprising a polyolefin.

### BRIEF DESCRIPTION OF THE DRAWINGS

For a better understanding of the present embodiments, reference may be had to the accompanying figures.

FIG. 1 is a graph illustrating particle size distribution of a dispersion of the toner additive made according to the present embodiments;

FIG. 2 is a graph illustrating 75° gloss as a function of fuser roll temperature for control toners;

FIG. 3 is a graph illustrating crease area as a function of fuser roll temperature for control toners;

FIG. 4 is a graph illustrating 75° gloss as a function of fuser roll temperature for control toners as compared to a toners made according to the present embodiments;

FIG. 5 is a graph illustrating crease area as a function of fuser roll temperature for control toners as compared to a toners made according to the present embodiments;

FIG. 6 is a graph illustrating fusing latitude for control toners as compared to a control toners made according to the present embodiments; and

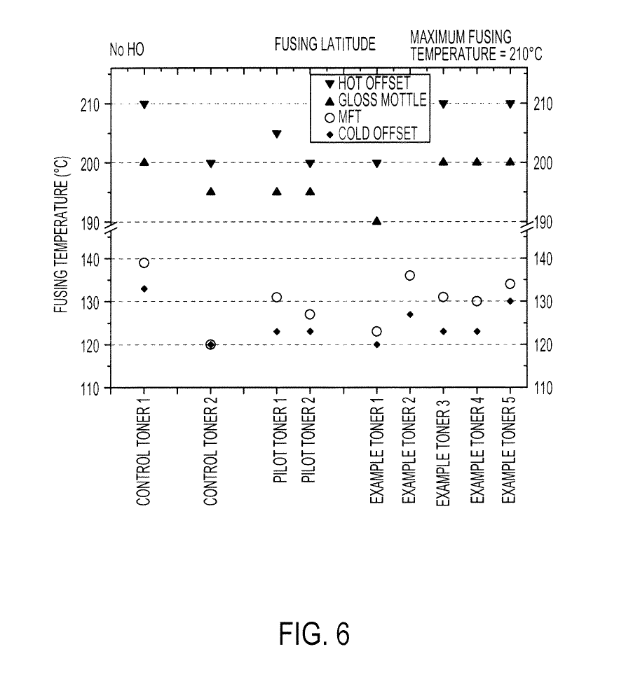

FIG. 7A is a graphical representation of a first portion of a chart showing where hot offset and gloss mottle was found during the fusing run with an in-house fusing fixture;

FIG. 7B is a graphical representation of a second portion of a chart showing where hot offset and gloss mottle was found during the fusing run with an in-house fusing fixture;

FIG. 7C is a graphical representation of a third portion of a chart showing where hot offset and gloss mottle was found during the fusing run with an in-house fusing fixture.

### DETAILED DESCRIPTION

As discussed above, known methods to control gloss through alteration of the system operations negatively impact performance. Gloss levels can also be controlled by additives included in the toners. Previously, additives comprising cross-linked resin or gel were included in toner particles to attempt to control the gloss of the printed images. By varying the amount of cross-linked resin or gel the toner particles, the extent of gloss the printed toner image exhibits can be controlled or “tuned”. However, these additives also suffered disadvantages. For example, the molecular weight of the cross-linked resin or gel is difficult to evaluate by gel permeation chromatography (GPC) since a portion of the gel is insoluble in solvents. In addition, the molecular weight of the soluble portion of the cross-linked resin ranges from 100,000 to 200,000 and tends to negatively impact the low temperature fixability of toner.

Another approach to varying gloss of the toner is by varying the amount if aluminum content in the toner. Glossy toners can have aluminum content ranging from about 20 ppm to about 200 ppm and matte toners can have aluminum content from about 500 ppm to 1000 ppm. U.S. Pat. No. 8,431,302 discloses clear toner in two formulations, one glossy and one matte for blending at ratios of from 10:90 to 90:10 and can achieve gloss levels from about 5 Gardner Gloss Units (ggu) to about 90 ggu. However, this approach is only satisfactory in limited situations, namely, for clear coat applications and when a fifth, and in some cases, sixth, housing option is available. In addition, when implemented, this method provides toners that are typically only either very high gloss (with low levels of aluminum) or very low gloss (with high levels of residual aluminum).

Toner Additives

The present embodiments provide a toner composition comprising at least a resin binder, colorant, wax and toner additive. The additive comprises polyolefins, such as for example, poly(1-octadecene). In embodiments, the additive comprises α-olefin having a carbon number of from about 3 to about 20, or more particularly, from about 3 to about 12. Examples of the such α-olefins are propylene, 1-butene, 1-pentene, 1-hexene, 4-methyl-1-pentene, 1-heptene, 1-octene, 1-decene, 1-dodecene, 1-hexadecene, 1-eicosene and the like. Of these α-olefins, octene is preferred, to thereby provide ethylene-α-octene as a preferred elastomer. In embodiments, the elastomers are produced using metallocene catalysts. However, other types of catalyst systems (e.g. Zeigler-Natta catalysts, constrained geometry catalysts, or the like) may also be suitable.]

In other embodiments, the additive comprises a polyolefin have a melting point of from about 40° C. to about 160° C., or from about 50° C. to about 120° C., or from about 60° C. to about 90° C. The polyolefin may have a weight average molecular weight (Mw) from about 500 to about 1,000,000, or from about 1,000 to about 200.000, or from about 5,000 to about 100,000.

Polyolefins have low surface energy—often less than 34 dynes/cm. α-olefins such as 1-butene, 1-hexene, and 1-octene are used to decrease the density and crystallinity of the polyolefin, changing its physical properties and applications. The toner additives of the present embodiments provide the ability to tune gloss levels of the toner without having any adverse impact on other properties of the toner or toner performance. The present embodiments provide a toner additive that allows the ability to tune gloss levels of the toner. These toner additives comprise polyolefins. Prior toners have used polymers of this type, for example, U.S. Pat. No. 4,952,477 and E.P. 0220319 A1. However, these references described only generally adding polyolefins into conventional toner compositions rather than specifically incorporating into the particle core and were not concerned with gloss. In contrast, the present embodiments incorporate the polyolefins into the particle core by making an emulsion of the polyolefin and later aggregating the polyolefin with the toner pre-composition.

In one of the present embodiments, the additive is a poly(1-octadecene). In such embodiments, the poly(1-octadecene) is used as a component in the core of an emulsion aggregation styrene acrylate type toner. The resulting toner exhibits gloss control without any significant adverse impact on the minimum fix properties of the toner. In embodiments, the resulting toner imparts low gloss (matte) to printed images. Without being bound by any theory, it is believed that the properties of poly(1-octadecene) such as haziness and opaqueness, broad molecular weight distribution and low density are the major contributors to the low gloss that is imparted to the toner composition incorporating the polyolefin. The surface matte appearance of toner is the result of incident light scattering upon reflection. By varying the amount of polyolefin such as poly(1-octadecene) in the toner, this incident light scattering effect can be controlled.

In embodiments, the additive is used as a component in the core of the toner particle at an amount of from about 1 to about 50%, or from about 1 to about 20%, or from about 1 to about 10% by weight of the toner. In addition, colorants, waxes, and other additives may be used to form the toner pre-compositions by incorporating in dispersions including surfactants and residual flocculant such as polyaluminum chloride (PAC). In embodiments the toner comprises a resin selected from the group consisting of vinyl, polyester, and crosslinked polymers such as styrene-1,2-butadiene copolymers. Illustrative examples of suitable toner resins selected for the toner and developer compositions of the present invention include polyamides, polycarbonates, epoxies, polyurethanes, vinyl resins and polymeric esterification products of a dicarboxylic acid and a diol comprising a diphenol. Any suitable vinyl resin may be selected for the toner resins of the present application including homopolymers or copolymers of two or more vinyl monomers. Typical of such vinyl monomeric units include: styrene, p-chlorostyrene, vinyl naphthalene, unsaturated mono-olefins such as ethylene, propylene, butylene, isobutylene and the like; diolefins, such as butadiene and the like; vinyl halides such as vinyl chloride, vinyl bromide, vinyl fluoride, vinyl acetate, vinyl propionate, vinyl benzoate, vinyl butyrate and other similar vinyl substances; vinyl esters such as esters of monocarboxylic acids including methyl acrylate, ethyl acrylate, n-butylacrylate, isobutyl acrylate, dodecyl acrylate, n-octyl acrylate, 2-chloroethyl acrylate, phenyl acrylate, methylalpha-chloroacrylate, methyl methacrylate, ethyl methacrylate, butyl methacrylate, and the like; acrylonitrile, methacrylonitrile, acrylamide, vinyl ethers, such as vinyl methyl ether, vinyl isobutyl ether, vinyl ethyl ether, and the like; vinyl ketones such as vinyl methyl ketone, vinyl hexyl ketone, methyl isopropenyl ketone and the like; vinylidene halides such as vinylidene chloride, vinylidene chlorofluoride and the like; and N-vinyl indole, N-vinyl pyrrolidine and the like; styrene butadiene copolymers, and mixtures thereof.

In specific embodiments, the additive is present in the core of the tone particle at about 10% by weight of a styrene acrylate emulsion aggregation toner, some embodiments, the vinyl polymer such as styrene acrylate toner has a particle core comprising the first monomer composition and the second monomer composition which may be independent of each other comprise two or three or more different monomers. The latex polymer therefore can comprise a copolymer. Illustrative examples of such latex copolymers include poly(styrene-n-butyl acrylate-(β-CEA), poly(styrene-alkyl acrylate), poly(styrene-1,3-diene), poly(styrene-1,2-diene), poly(styrene-1,4-diene), poly(styrene-alkyl methacrylate), poly(alkyl methacrylate-alkyl acrylate), poly(alkyl methacrylate-aryl acrylate), poly(aryl methacrylate-alkyl acrylate), poly(alkyl methacrylate), poly(styrene-alkyl acrylate-acrylonitrile), poly(styrene-1,3-diene-acrylonitrile), poly(alkyl acrylate-acrylonitrile), poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene); poly(styrene-propyl acrylate), poly(styrene-butyl acrylate), poly(styrene-butadiene-acrylonitrile), poly(styrene-butyl acrylate-acrylonitrile) and the like.

The core has a lower glass transition (Tgₒₙ) than the particle shell. In embodiments, the Tgₒₙ of the particle core is from about 0 to about 50, from about 0 to about 20, from about 0 to about 10 lower than the Tgₒₙ of the particle shell.

In embodiments, the polyolefin has a weight average molecular weight (Mw) of from about 500 to about 1,000,000, or from about 1,000 to about 200,000, or from about 5,000 to about 100,000. In embodiments, the polyolefin has a number average molecular weight (Mn) of from about 300 to about 500,000, or from about 500 to about 100,000, or from about 800 to about 50,000. In embodiments, the polyolefin has a polydispersity (PD) of from about 1.0 to about 50, or from about 2.0 to about 30, or from about 4.0 to about 20. In embodiments, the polyolefin has a melting point of from about 4.0 to about 160, or from about 50 to about 120, or from about 60 to about 90.

In the present embodiments, the toner comprising the gloss reducing additive has a low gloss level from about 5 to about 90 ggu, or from about 10 to about 80 ggu, or from about 20 to about 60 ggu. The more additive is included, the lower the gloss level of the resulting toner will be.

Latex Resin

In embodiments, a developer is disclosed including a resin coated carrier and a toner, where the toner may be an emulsion aggregation toner, containing, but not limited to, a latex resin, a wax and a polymer shell.

In embodiments, the latex resin may be composed of a first and a second monomer composition. Any suitable monomer or mixture of monomers may be selected to prepare the first monomer composition and the second monomer composition. The selection of monomer or mixture of monomers for the first monomer composition is independent of that for the second monomer composition and vice versa. Exemplary monomers for the first and/or the second monomer compositions include, but are not limited to, polyesters, styrene, alkyl acrylate, such as, methyl acrylate, ethyl acrylate, butyl arylate, isobutyl acrylate, dodecyl acrylate, n-octyl acrylate, 2-chloroethyl acrylate; β-carboxy ethyl acrylate (β-CEA), phenyl acrylate, methyl alphachloroacrylate, methyl methacrylate, ethyl methacrylate and butyl methacrylate; butadiene; isoprene; methacrylonitrile; acrylonitrile; vinyl ethers, such as, vinyl methyl ether, vinyl isobutyl ether, vinyl ethyl ether and the like; vinyl esters, such as, vinyl acetate, vinyl propionate, vinyl benzoate and vinyl butyrate; vinyl ketones, such as, vinyl methyl ketone, vinyl hexyl ketone and methyl isopropenyl ketone; vinylidene halides, such as, vinylidene chloride and vinylidene chlorofluoride; N-vinyl indole; N-vinyl pyrrolidone; methacrylate; acrylic acid; methacrylic acid; acrylamide; methacrylamide; vinylpyridine; vinylpyrrolidone; vinyl-N-methylpyridinium chloride; vinyl naphthalene; p-chlorostyrene; vinyl chloride; vinyl bromide; vinyl fluoride; ethylene; propylene; butylenes; isobutylene; and the like, and mixtures thereof. In case a mixture of monomers is used, typically the latex polymer will be a copolymer.

In some embodiments, the first monomer composition and the second monomer composition may independently of each other comprise two or three or more different monomers. (side note—sounds very similar to my entry above) The latex polymer therefore can comprise a copolymer. Illustrative examples of such a latex copolymer includes poly(styrene-n-butyl acrylate-β-CEA), poly(styrene-alkyl acrylate), poly(styrene-1,3-diene), poly(styrene-alkyl methacrylate), poly(alkyl methacrylate-alkyl acrylate), poly(alkyl methacrylate-aryl acrylate), poly(aryl methacrylate-alkyl acrylate), poly(alkyl methacrylate), poly(styrene-alkyl acrylate-acrylonitrile), poly(styrene-1,3-diene-acrylonitrile), poly(alkyl acrylate-acrylonitrile), poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene); poly(styrene-propyl acrylate), poly(styrene-butyl acrylate), poly(styrene-butadiene-acrylonitrile), poly(styrene-butyl acrylate-acrylononitrile), and the like.

In embodiments, the first monomer composition and the second monomer composition may be substantially water insoluble, such as, hydrophobic, and may be dispersed in an aqueous phase with adequate stirring when added to a reaction vessel.

The weight ratio between the first monomer composition and the second monomer composition may be in the range of from about 0.1:99.9 to about 50:50, including from about 0.5:99.5 to about 25:75, from about 1:99 to about 10:90.

In embodiments, the first monomer composition and the second monomer composition can be the same. Examples of the first/second monomer composition may be a mixture comprising styrene and alkyl acrylate, such as, a mixture comprising styrene, n-butyl acrylate and 3-CEA. Based on total weight of the monomers, styrene may be present in an amount from about 1% to about 99%, from about 50% to about 95%, from about 70% to about 90%, although may be present in greater or lesser amounts; alkyl acrylate, such as, n-butyl acrylate, may be present in an amount from about 1% to about 99%, from about 5% to about 50%, from about 10% to about 30%, although may be present in greater or lesser amounts.

In embodiments, the resins may be a polyester resin, such as, an amorphous resin, a crystalline resin, and/or a combination thereof, including the resins described in U.S. Pat. Nos. 6,593,049 and 6,756,176, the disclosure of each of which hereby is incorporated by reference in entirety. Suitable resins may also include a mixture of an amorphous polyester resin and a crystalline polyester resin as described in U.S. Pat. No. 6,830,860, the disclosure of which is hereby incorporated by reference in entirety.

In embodiments, the resin may be a polyester resin formed by reacting a diol with a diacid in the presence of an optional catalyst. For forming a crystalline polyester, suitable organic diols include aliphatic diols with from about 2 to about 36 carbon atoms, such as 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol and the like; alkali sulfo-aliphatic diols such as sodio 2-sulfo-1,2-ethanediol, lithio 2-sulfo-1,2-ethanediol, potassio 2-sulfo-1,2-ethanediol, sodio 2-sulfo-1,3-propanediol, lithio 2-sulfo-1,3-propanediol, potassio 2-sulfo-1,3-propanediol, mixture thereof, and the like. The aliphatic diol may be, for example, selected in an amount of from about 40 to about 60 mole percent, in embodiments from about 42 to about 55 mole percent, in embodiments from about 45 to about 53 mole percent (although amounts outside of these ranges can be used), and the alkali sulfo-aliphatic diol can be selected in an amount of from about 0 to about 10 mole percent, in embodiments from about 1 to about 4 mole percent of the resin.

Examples of organic diacids or diesters including vinyl diacids or vinyl diesters selected for the preparation of the crystalline resins include oxalic acid, succinic acid, glutaric acid, adipic acid, suberic acid, azelaic acid, sebacic acid, fumaric acid, dimethyl fumarate, dimethyl itaconate, cis, 1,4-diacetoxy-2-butene, diethyl fumarate, diethyl maleate, phthalic acid, isophthalic acid, terephthalic acid, naphthalene-2,6-dicarboxylic acid, naphthalene-2,7-dicarboxylic acid, cyclohexane dicarboxylic acid, malonic acid and mesaconic acid, a diester or anhydride thereof; and an alkali sulfo-organic diacid such as the sodio, lithio or potassio salt of dimethyl-5-sulfo-isophthalate, dialkyl-5-sulfo-isophthalate-4-sulfo-1,8-naphthalic anhydride, 4-sulfo-phthalic acid, dimethyl-4-sulfo-phthalate, dialkyl-4-sulfo-phthalate, 4-sulfophenyl-3,5-dicarbomethoxybenzene, 6-sulfo-2-naphthyl-3,5-dicarbomethoxybenzene, sulfo-terephthalic acid, dimethyl-sulfo-terephthalate, 5-sulfo-isophthalic acid, dialkyl-sulfo-terephthalate, sultoethanediol, 2-sulfopropanediol, 2-sulfobutanediol, 3-sulfopentanediol, 2-sulfohexanediol, 3-sulfo-2-methylpentanediol, 2-sulfo-3,3-dimethylpentanediol, sulfo-p-hydroxybenzoic acid, N,N-bis(2-hydroxyethyl)-2-amino ethane sulfonate, or mixtures thereof. The organic diacid may be selected in an amount of, for example, in embodiments from about 40 to about 60 mole percent, in embodiments from about 42 to about 52 mole percent, in embodiments from about 45 to about 50 mole percent, and the alkali sulfo-aliphatic diacid can be selected in an amount of from about 1 to about 10 mole percent of the resin.

Examples of crystalline resins include polyesters, polyamides, polyimides, polyolefins, polyethylene, polybutylene, polyisobutyrate, ethylene-propylene copolymers, ethylene-vinyl acetate copolymers, polypropylene, mixtures thereof, and the like. Specific crystalline resins may be polyester based, such as poly(ethylene-adipate), poly(propylene-adipate), poly(butylene-adipate), poly(pentylene-adipate), poly(hexylene-adipate), poly(octylene-adipate), poly(ethylene-succinate), poly(propylene-succinate), poly(butylene-succinate), poly(pentylene-succinate), poly(hexylene-succinate), poly(octylene-succinate), poly(ethylene-sebacate), poly(propylene-sebacate), poly(butylene-sebacate), poly(pentylene-sebacate), poly(hexylene-sebacate), poly(octylene-sebacate), poly(decylene-sebacate), poly(decylene-decanoate), poly(ethylene-decanoate), poly(ethylene dodecanoate), poly(nonylene-sebacate), poly(nonylene-decanoate), copoly(ethylene-fumarate)-copoly(ethylene-sebacate), copoly(ethylene-fumarate)-copoly(ethylene-decanoate), copoly(ethylene-fumarate)-copoly(ethylene-dodecanoate), alkali copoly(5-sulfoisophthaloyl)-copoly(ethylene-adipate), alkali copoly(5-sulfoisophthaloyl)-copoly(propylene-adipate), alkali copoly(5-sulfoisophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), alkali copoly(5-sulfo-isophthaloyl)-copoly(octylene-adipate), alkali copoly(5-sulfo-isophthaloyl)-copoly(ethylene-adipate), alkali copoly(5-sulfo-isophthaloyl)-copoly(propylene-adipate), alkali copoly(5-sulfo-isophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), alkali copoly(5-sulfo-isophthaloyl)-copoly(octylene-adipate), alkali copoly(5-sulfoisophthaloyl)-copoly(ethylene-succinate), alkali copoly(5-sulfoisophthaloyl)-copoly(propylene-succinate), alkali copoly(5-sulfoisophthaloyl)-copoly(butylenes-succinate), alkali copoly(5-sulfoisophthaloyl)-copoly(pentylene-succinate), alkali copoly(5-sulfoisophthaloyl)-copoly(hexylene-succinate), alkali copoly(5-sulfoisophthaloyl)-copoly(octylene-succinate), alkali copoly(5-sulfo-isophthaloyl)-copoly(ethylene-sebacate), alkali copoly(5-sulfo-isophthaloyl)-copoly(propylene-sebacate), alkali copoly(5-sulfo-isophthaloyl)-copoly(butylene-sebacate), alkali copoly(5-sulfo-isophthaloyl)-copoly(pentylene-sebacate), alkali copoly(5-sulfo-isophthaloyl)-copoly(hexylene-sebacate), alkali copoly(5-sulfo-isophthaloyl)-copoly(octylene-sebacate), alkali copoly(5-sulfo-isophthaloyl)-copoly(ethylene-adipate), alkali copoly(5-sulfo-isophthaloyl)-copoly(propylene-adipate), alkali copoly(5-sulfo-isophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), poly(octylene-adipate), wherein alkali is a metal like sodium, lithium or potassium. Examples of polyamides include poly(ethylene-adipamide), poly(propylene-adipamide), poly(butylenes-adipamide), poly(pentylene-adipamide), poly(hexylene-adipamide), poly(octylene-adipamide), poly(ethylene-succinimide), and poly(propylene-sebecamide). Examples of polyimides include poly(ethylene-adipimide), poly(propylene-adipimide), poly(butylene-adipimide), poly(pentylene-adipimide), poly(hexylene-adipimide), poly(octylene-adipimide), poly(ethylene-succinimide), poly(propylene-succinimide), and poly(butylene-succinimide).

The crystalline resin may be present, for example, in an amount of from about 5 to about 50 percent by weight of the toner components, in embodiments from about 10 to about 35 percent by weight of the toner components. The crystalline resin can possess various melting points of, for example, from about 30° C. to about 120° C., in embodiments from about 50° C. to about 90° C. The crystalline resin may have a number average molecular weight (Mₙ), as measured by gel permeation chromatography (GPC) of, for example, from about 1,000 to about 50,000, in embodiments from about 2,000 to about 25.000, and a weight average molecular weight (M_{w}) of, for example, from about 2,000 to about 100,000, in embodiments from about 3,000 to about 80,000, as determined by Gel Permeation Chromatography using polystyrene standards. The molecular weight distribution (M_{w}/Mₙ) of the crystalline resin may be, for example, from about 2 to about 6, in embodiments from about 3 to about 4.

Examples of diacids or diesters including vinyl diacids or vinyl diesters utilized for the preparation of amorphous polyesters include dicarboxylic acids or diesters such as terephthalic acid, phthalic acid, isophthalic acid, fumaric acid, dimethyl fumarate, dimethyl itaconate, cis, 1,4-diacetoxy-2-butene, diethyl fumarate, diethyl maleate, maleic acid, succinic acid, itaconic acid, succinic acid, succinic anhydride, dodecylsuccinic acid, dodecylsuccinic anhydride, glutaric acid, glutaric anhydride, adipic acid, pimelic acid, suberic acid, azelaic acid, dodecane diacid, dimethyl terephthalate, diethyl terephthalate, dimethylisophthalate, diethylisophthalate, dimethylphthalate, phthalic anhydride, diethylphthalate, dimethylsuccinate, dimethylfumarate, dimethylmaleate, dimethylglutarate, dimethyladipate, dimethyl dodecylsuccinate, and combinations thereof. The organic diacid or diester may be present, for example, in an amount from about 40 to about 60 mole percent of the resin, in embodiments from about 42 to about 52 mole percent of the resin, in embodiments from about 45 to about 50 mole percent of the resin. Examples of the alkylene oxide adducts of bisphenol include polyoxypropylene (2.2)-2,2-bis(4-hydroxyphenyl) propane, polyoxypropylene (3.3)-2,2-bis(4-hydroxyphenyl) propane, polyoxyethylene (2.0)-2,2-bis(4-hydroxyphenyl) propane, polyoxyethylene (2.2)-2,2-bis(4-hydroxyphenyl) propane, polyoxypropylene (2.0)-polyoxyethylene (2.0)-2,2-bis(4-hydroxyphenyl) propane, and polyoxypropylene (6)-2,2-bis(4-hydroxyphenyl) propane. These compounds may be used singly or as a combination of two or more thereof.

Examples of additional diols which may be utilized in generating the amorphous polyester include 1,2-propanediol, 1,3-propanediol, 1,2-butanediol, 1,3-butanediol, 1,4-butanediol, pentanediol, hexanediol, 2,2-dimethylpropanediol, 2,2,3-trimethylhexanediol, heptanediol, dodecanediol, 1,4-cyclohexanedimethanol, 1,3-cyclohexanedimethanol, xylenedimethanol, cyclohexanediol, diethylene glycol, dipropylene glycol, dibutylene, and combinations thereof. The amount of organic diol selected can vary, and may be present, for example, in an amount from about 40 to about 60 mole percent of the resin, in embodiments from about 42 to about 55 mole percent of the resin, in embodiments from about 45 to about 53 mole percent of the resin.

Polycondensation catalysts which may be utilized in forming either the crystalline or amorphous polyesters include tetraalkyl titanates, dialkyltin oxides such as dibutyltin oxide, tetraalkyltins such as dibutyltin dilaurate, and dialkyltin oxide hydroxides such as butyltin oxide hydroxide, aluminum alkoxides, alkyl zinc, dialkyl zinc, zinc oxide, stannous oxide, or combinations thereof. Such catalysts may be utilized in amounts of, for example, from about 0.01 mole percent to about 5 mole percent based on the starting diacid or diester used to generate the polyester resin.

In embodiments, suitable amorphous resins include polyesters, polyamides, polyimides, polyolefins, polyethylene, polybutylene, polyisobutyrate, ethylene-propylene copolymers, ethylene-vinyl acetate copolymers, polypropylene, combinations thereof, and the like. Examples of amorphous resins which may be utilized include alkali sulfonated-polyester resins, branched alkali sulfonated-polyester resins, alkali sulfonated-polyimide resins, and branched alkali sulfonated-polyimide resins. Alkali sulfonated polyester resins may be useful in embodiments, such as the metal or alkali salts of copoly(ethylene-terephthalate)-copoly(ethylene-5-sulfo-isophthalate), copoly(propylene-terephthalate)-copoly(propylene-5-sulfo-isophthalate), copoly(diethylene-terephthalate)-copoly(diethylene-5-sulfo-isophthalate), copoly(propylene-diethylene-terephthalate)-copoly(propylene-diethylene-5-sulfo-isophthalate), copoly(propy ene-butylene-terephthalate)-copoly(propylene-butylene-5-sulfo-isophthalate), copoly(propoxylated bisphenol-A-fumarate)-copoly(propoxylated bisphenol A-5-sulfo-isophthalate), copoly(ethoxylated bisphenol-A-fumarate)-copoly(ethoxylated bisphenol-A-5-sulfo-isophthalate), and copoly(ethoxylated bisphenol-A-maleate)-copoly(ethoxylated bisphenol-A-5-sulfo-isophthalate), wherein the alkali metal is, for example, a sodium, lithium or potassium ion.

In embodiments, as noted above, an unsaturated amorphous polyester resin may be utilized as a latex resin. Examples of such resins include those disclosed in U.S. Pat. No. 6,063,827, the disclosure of which is hereby incorporated by reference in its entirety. Exemplary unsaturated amorphous polyester resins include, but are not limited to, poly(propoxylated bisphenol co-fumarate), poly(ethoxylated bisphenol co-fumarate), poly(butyloxylated bisphenol co-fumarate), poly(co-propoxylated bisphenol co-ethoxylated bisphenol co-fumarate), poly(1,2-propylene fumarate), poly(propoxylated bisphenol co-maleate), poly(ethoxylated bisphenol co-maleate), poly(butyloxylated bisphenol co-maleate), poly(co-propoxylated bisphenol co-ethoxylated bisphenol co-maleate), poly(1,2-propylene maleate), poly(propoxylated bisphenol co-itaconate), poly(ethoxylated bisphenol co-itaconate), poly(butyloxylated bisphenol co-itaconate), poly(co-propoxylated bisphenol co-ethoxylated bisphenol co-itaconate), poly(1,2-propylene itaconate), and combinations thereof.

Furthermore, in embodiments, a crystalline polyester resin may be contained in the binding resin. The crystalline polyester resin may be synthesized from an acid (dicarboxylic acid) component and an alcohol (diol) component. In what follows, an “acid-derived component” indicates a constituent moiety that was originally an acid component before the synthesis of a polyester resin and an “alcohol-derived component” indicates a constituent moiety that was originally an alcoholic component before the synthesis of the polyester resin.

A “crystalline polyester resin” indicates one that shows not a stepwise endothermic amount variation but a clear endothermic peak in differential scanning calorimetry (DSC). However, a polymer obtained by copolymerizing the crystalline polyester main chain and at least one other component is also called a crystalline polyester if the amount of the other component is 50% by weight or less.

As the acid-derived component, an aliphatic dicarboxylic acid may be utilized, such as a straight chain carboxylic acid, Examples of straight chain carboxylic acids include oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid, 1,1-undecanedicarboxylic acid, 1,12-dodecanedicarboxylic acid, 1,13-tridecanedicarboxylic acid, 1,14-tetradecanedicarboxylic acid, 1,16-hexadecanedicarboxylic acid, and 1,18-octadecanedicarboxylic acid, as well as lower alkyl esters and acid anhydrides thereof. Among these, acids having 6 to 10 carbon atoms may be desirable for obtaining suitable crystal melting point and charging properties. In order to improve the crystallinity, the straight chain carboxylic acid may be present in an amount of about 95% by mole or more of the acid component and, in embodiments, more than about 98% by mole of the acid component. Other acids are not particularly restricted, and examples thereof include conventionally known divalent carboxylic acids and dihydric alcohols, for example those described in “Polymer Data Handbook: Basic Edition” (Soc. Polymer Science, Japan Ed.: Baihukan). Specific examples of the monomer components include, as divalent carboxylic acids, dibasic acids such as phthalic acid, isophthalic acid, terephthalic acid, naphthalene-2,6-dicarboxylic acid, naphthalene-2,7-dicarboxylic acid, and cyclohexanedicarboxylic acid, and anhydrides and lower alkyl esters thereof, as well as combinations thereof, and the like. As the acid-derived component, a component such as a dicarboxylic acid-derived component having a sulfonic acid group may also be utilized. The dicarboxylic acid having a sulfonic acid group may be effective for obtaining excellent dispersion of a coloring agent such as a pigment. Furthermore, when a whole resin is emulsified or suspended in water to prepare a toner mother particle, a sulfonic acid group, may enable the resin to be emulsified or suspended without a surfactant. Examples of such dicarboxylic acids having a sulfonic group include, but are not limited to, sodium 2-sulfoterephthalate, sodium 5-sulfoisophthalate and sodium sulfosuccinate. Furthermore, lower alkyl esters and acid anhydrides of such dicarboxylic acids having a sulfonic group, for example, are also usable. Among these, sodium 5-sulfoisophthalate and the like may be desirable in view of the cost. The content of the dicarboxylic acid having a sulfonic acid group may be from about 0.1% by mole to about 2% by mole, in embodiments from about 0.2% by mole to about 1% by mole. When the content is more than about 2% by mole, the charging properties may be deteriorated. Here, “component mol %” or “component mole %” indicates the percentage when the total amount of each of the components (acid-derived component and alcohol-derived component) in the polyester resin is assumed to be 1 unit (mole).

As the alcohol component, aliphatic dialcohols may be used. Examples thereof include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-dodecanediol, 1,12-undecanediol, 1,13-tridecanediol, 1,14-tetradecanediol, 1,18-octadecanediol and 1,20-eicosanediol. Among them, those having from about 6 to about 10 carbon atoms may be used to obtain desirable crystal melting points and charging properties. In order to raise crystallinity, it may be useful to use the straight chain dialcohols in an amount of about 95% by mole or more, in embodiments about 98% by mole or more.

Examples of other dihydric dialcohols which may be utilized include bisphenol A, hydrogenated bisphenol A, bisphenol A ethylene oxide adduct, bisphenol A propylene oxide adduct, 1,4-cyclohexanediol, 1,4-cyclohexanedimethanol, diethylene glycol, propylene glycol, dipropylene glycol, 1,3-butanediol, neopentyl glycol, combinations thereof, and the like.

For adjusting the acid number and hydroxyl number, the following may be used: monovalent acids such as acetic acid and benzoic acid; monohydric alcohols such as cyclohexanol and benzyl alcohol; benzenetricarboxylic acid, naphthalenetricarboxylic acid, and anhydrides and lower alkylesters thereof; trivalent alcohols such as glycerin, trimethylolethane, trimethylolpropane, pentaerythritol, combinations thereof, and the like.

The crystalline polyester resins may be synthesized from a combination of components selected from the above-mentioned monomer components, by using conventional known methods. Exemplary methods include the ester exchange method and the direct polycondensation method, which may be used singularly or in a combination thereof. The molar ratio (acid component/alcohol component) when the acid component and alcohol component are reacted, may vary depending on the reaction conditions. The molar ratio is usually about 1/1 in direct polycondensation. In the ester exchange method, a monomer such as ethylene glycol, neopentyl glycol or cyclohexanedimethanol, which may be distilled away under vacuum, may be used in excess.

Surfactants

Any suitable surfactants may be used for the preparation of the latex and wax dispersions according to the present disclosure. Depending on the emulsion system, any desired nonionic or ionic surfactant such as anionic or cationic surfactant may be contemplated.

Examples of suitable anionic surfactants include, but are not limited to, sodium dodecylsulfate, sodium dodecylbenzene sulfonate, sodium dodecylnaphthalenesulfate, dialkyl benzenealkyl sulfates and sulfonates, abitic acid, NEOGEN R® and NEOGEN SC® available from Kao, Tayca Power®, available from Tayca Corp., DOWFAX®, available from Dow Chemical Co., and the like, as well as mixtures thereof. Anionic surfactants may be employed in any desired or effective amount, for example, at least about 0.01% by weight of total monomers used to prepare the latex polymer, at least about 0.1% by weight of total monomers used to prepare the latex polymer; and no more than about 10% by weight of total monomers used to prepare the latex polymer, no more than about 5% by weight of total monomers used to prepare the latex polymer, although the amount can be outside of those ranges.

Examples of suitable cationic surfactants include, but are not limited to, dialkyl benzenealkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide. C₁₂, C₁₅ and C₁₇ trimethyl ammonium bromides, halide salts of quaternized polyoxyethylalkylamines, dodecylbenzyl triethyl ammonium chloride, MIRAPOL® and ALKAQUAT® (available from Alkaril Chemical Company), SANIZOL® (benzalkonium chloride, available from Kao Chemicals), and the like, as well as mixtures thereof.

Examples of suitable nonionic surfactants include, but are not limited to, polyvinyl alcohol, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxypoly(ethyleneoxy)ethanol (available from Rhone-Poulenc as IGEPAL CA-210®, IGEPAL CA-520®, IGEPAL CA-720®, IGEPAL CO-890®, IGEPAL CO-720®, IGEPAL CO-290®, IGEPAL CA-210®, ANTAROX 890®, and ANTAROX 897®) and the like, as well as mixtures thereof.

Initiators

Any suitable initiator or mixture of initiators may be selected in the latex process and the toner process. In embodiments, the initiator is selected from known free radical polymerization initiators. The free radical initiator can be any free radical polymerization initiator capable of initiating a free radical polymerization process and mixtures thereof, such free radical initiator being capable of providing free radical species on heating to above about 30° C.

Although water soluble free radical initiators are used in emulsion polymerization reactions, other free radical initiators also can be used. Examples of suitable free radical initiators include, but are not limited to, peroxides, such as, ammonium persulfate, hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethylbenzoyl peroxide, lauroyl peroxide, diisopropyl peroxycarbonate, tetralin hydroperoxide, 1-phenyl-2-methylpropyl-1-hydroperoxide and tert-butylhydroperoxide; pertriphenylacetate, tert-butyl performate; tert-butyl peracetate; tert-butyl perbenzoate; tert-butyl perphenylacetate; tert-butyl permethoxyacetate; tert-butyl per-N-(3-toluyl)carbamate; sodium persulfate; potassium persulfate, azo compounds, such as, 2,2′-azobispropane, 2,2′-dichloro-2,2′-azobispropane, 1,1′-azo(methylethyl)diacetate, 2,2′-azobis(2-amidinopropane)hydrochloride, 2,2′-azobis(2-amidinopropane)-nitrate, 2,2′-azobisisobutane, 2,2′-azobisisobutylamide, 2,2′-azobisisobutyronitrile, methyl 2,2′-azobis-2-methylpropionate, 2,2′-dichloro-2,2′-azobisbutane, 2,2′-azobis-2-methylbutyronitrile, dimethyl 2,2′-azobisisobutyrate, 1,1′-azobis(sodium 1-methylbutyronitrile-3-sulfonate), 2-(4-methylphenylazo)-2-methylmalonod-initrile, 4,4′-azobis-4-cyanovaleric acid, 3,5-dihydroxymethylphenylazo-2-methylmalonodinitrile, 2-(4-bromophenylazo)-2-allylmalonodinitrile, 2,2′-azobis-2-methylvaleronitrile, dimethyl 4,4′-azobis-4-cyanovalerate, 2,2′-azobis-2,4-dimethylvaleronitrile, 1,1′-azobiscyclohexanenitrile, 2,2′-azobis-2-propylbutyronitrile, 1,1′-azobis-1-chlorophenylmethane, 1,1′-azobis-1-cyclohexanecarbonitrile, 1,1′-azobis-1-cycloheptanenitrile, 1,1′-azobis-1-phenylethane, 1,1′-azobiscumene, ethyl 4-nitrophenylazobenzylcyanoacetate, phenylazodiphenylmethane, phenylazotriphenylmethane, 4-nitrophenylazotriphenylmethane, 1′-azobis-1,2-diphenylethane, poly(bisphenol A-4,4′-azobis-4-cyanopentano-ate) and poly(tetraethylene glycol-2,2′-azobisisobutyrate); 1,4-bis(pentaethylene)-2-tetrazene; 1,4-dimethoxycarbonyl-1,4-dipheny-1-2-tetrazene and the like; and mixtures thereof.

More typical free radical initiators include, but are not limited to, ammonium persulfate, hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethylbenzoyl peroxide, lauroyl peroxide, sodium persulfate, potassium persulfate, diisopropyl peroxycarbonate and the like.

Based on total weight of the monomers to be polymerized, the initiator may be present in an amount from about 0.1% to about 5%, from about 0.4% to about 4%, from about 0.5% to about 3%, although may be present in greater or lesser amounts.

A chain transfer agent optionally may be used to control the polymerization degree of the latex, and thereby control the molecular weight and molecular weight distribution of the product latexes of the latex process and/or the toner process according to the present disclosure. As can be appreciated, a chain transfer agent can become part of the latex polymer.

Chain Transfer Agent

In embodiments, the chain transfer agent has a carbon-sulfur covalent bond. The carbon-sulfur covalent bond has an absorption peak in a wave number region ranging from 500 to 800 cm⁻¹ in an infrared absorption spectrum. When the chain transfer agent is incorporated into the latex and the toner made from the latex, the absorption peak may be changed, for example, to a wave number region of 400 to 4,000 cm⁻¹.

Exemplary chain transfer agents include, but are not limited to, n-C₃₋₁₅ alkylmercaptans, such as, n-propylmercaptan, n-butylmercaptan, n-amylmercaptan, n-hexylmercaptan, n-heptylmercaptan, n-octylmercaptan, n-nonylmercaptan, n-decylmercaptan and n-dodecylmercaptan; branched alkylmercaptans, such as, isopropylmercaptan, isobutylmercaptan, s-butylmercaptan, tert-butylmercaptan, cyclohexylmercaptan, tert-hexadecylmercaptan, tert-laurylmercaptan, tert-nonylmercaptan, tert-octylmercaptan and tert-tetradecylmercaptan; aromatic ring-containing mercaptans, such as, allylmercaptan, 3-phenylpropylmercaptan, phenylmercaptan and mercaptotriphenylmethane; and so on. The terms, mercaptan and thiol may be used interchangeably to mean C—SH group.

Examples of such chain transfer agents also include, but are not limited to, dodecanethiol, butanethiol, isooctyl-3-mercaptopropionate, 2-methyl-5-t-butyl-thiophenol, carbon tetrachloride, carbon tetrabromide and the like.

Based on total weight of the monomers to be polymerized, the chain transfer agent may be present in an amount from about 0.1% to about 7%, from about 0.5% to about 6%, from about 1.0% to about 5%, although may be present in greater or lesser amounts.

In embodiments, a branching agent optionally may be included in the first/second monomer composition to control the branching structure of the target latex. Exemplary branching agents include, but are not limited to, decanediol diacrylate (ADOD), trimethylolpropane, pentaerythritol, trimellitic acid, pyromellitic acid and mixtures thereof.

Based on total weight of the monomers to be polymerized, the branching agent may be present in an amount from about 0% to about 2%, from about 0.05% to about 1.0%, from about 0.1% to about 0.8%, although may be present in greater or lesser amounts.

In the latex process and toner process of the disclosure, emulsification may be done by any suitable process, such as, mixing at elevated temperature. For example, the emulsion mixture may be mixed in a homogenizer set at about 200 to about 400 rpm and at a temperature of from about 40° C. to about 80° C. for a period of from about 1 min to about 20 min.

Any type of reactor may be used without restriction. The reactor can include means for stirring the compositions therein, such as, an impeller. A reactor can include at least one impeller. For forming the latex and/or toner, the reactor can be operated throughout the process such that the impellers can operate at an effective mixing rate of about 10 to about 1,000 rpm.

Following completion of the monomer addition, the latex may be permitted to stabilize by maintaining the conditions for a period of time, for example for about 10 to about 300 min, before cooling. Optionally, the latex formed by the above process may be isolated by standard methods known in the art, for example, coagulation, dissolution and precipitation, filtering, washing, drying or the like.

The latex of the present disclosure may be selected for emulsion-aggregation-coalescence processes for forming toners, inks and developers by known methods. The latex of the present disclosure may be melt blended or otherwise mixed with various toner ingredients, such as, a wax dispersion, a coagulant, an optional silica, an optional charge enhancing additive or charge control additive, an optional surfactant, an optional emulsifier, an optional flow additive and the like. Optionally, the latex (e.g. around 40% solids) may be diluted to the desired solids loading (e.g. about 12 to about 15% by weight solids), before formulated in a toner composition.

Based on the total toner weight, the latex may be present in an amount from about 50% to about 100%, from about 60% to about 98%, from about 70% to about 95%, although may be present in greater or lesser amounts. Methods of producing such latex resins may be carried out as described in the disclosure of U.S. Pat. No. 7,524,602, herein incorporated by reference in entirety.

Colorants

Various known suitable colorants, such as dyes, pigments, mixtures of dyes, mixtures of pigments, mixtures of dyes and pigments and the like may be included in the toner. The colorant may be included in the toner in an amount of, for example, about 0.1 to about 35% by weight of the toner, from about 1 to about 15% percent of the toner, from about 3 to about 10% by weight of the toner, although amounts outside those ranges may be utilized.

As examples of suitable colorants, mention may be made of carbon black like REGAL 330®; magnetites, such as, Mobay magnetites MO8029™ and MO8060™; Colombian magnetites; MAPICO BLACKS™, surface-treated magnetites; Pfizer magnetites CB4799™, CB5300™, CB5600™ and MCX6369™; Bayer magnetites, BAYFERROX 8600™ and 8610™; Northern Pigments magnetites, NP-604™ and NP-608™; Magnox magnetites TMB-100™ or TMB-104™; and the like. As colored pigments, there can be selected cyan, magenta, yellow, red, green, brown, blue or mixtures thereof. Generally, cyan, magenta or yellow pigments or dyes, or mixtures thereof, are used. The pigment or pigments can be water-based pigment dispersions.

Specific examples of pigments include SUNSPERSE 6000, FLEXIVERSE and AQUATONE water-based pigment dispersions from SUN Chemicals, HELIOGEN BLUE L6900™, D6840™, D7080™, D7020™, PYLAM OIL BLUE™, PYLAM OIL YELLOW™, PIGMENT BLUE 1™ available from Paul Uhlich & Company, Inc., PIGMENT VIOLET 1™, PIGMENT RED 48™, LEMON CHROME YELLOW DCC 1026™, E.D. TOLUIDINE RED™ and BON RED C™ available from Dominion Color Corporation, Ltd., Toronto, Ontario, NOVAPERM YELLOW FGL™, HOSTAPERM PINK E™ from Hoechst, CINQUASIA MAGENTA™ available from E.I. DuPont de Nemours & Company and the like. Colorants that can be selected are black, cyan, magenta, yellow and mixtures thereof. Examples of magentas are 2,9-dimethyl-substituted quinacridone and anthraquinone dye identified in the Color Index as CI 60710, CI Dispersed Red 15, diazo dye identified in the Color Index as CI 26050, CI Solvent Red 19 and the like. Illustrative examples of cyans include copper tetra(octadecyl sulfonamido) phthalocyanine, x-copper phthalocyanine pigment listed in the Color Index as CI 74160. CI Pigment Blue, Pigment Blue 15:3, Anthrathrene Blue, identified in the Color Index as CI 69810, Special Blue X-2137 and the like. Illustrative examples of yellows are diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,5-dimethoxy acetoacetanilide and Permanent Yellow FGL. Colored magnetites, such as, mixtures of MAPICO BLACK™, and cyan components also may be selected as colorants. Other known colorants can be selected, such as, Levanyl Black A-SF (Miles, Bayer) and Sunsperse Carbon Black LHD 9303 (Sun Chemicals), and colored dyes, such as, Neopen Blue (BASF), Sudan Blue OS (BASF), PV Fast Blue B2G01 (American Hoechst), Sunsperse Blue BHD 6000 (Sun Chemicals), Irgalite Blue BCA (Ciba-Geigy), Paliogen Blue 6470 (BASF), Sudan III (Matheson, Coleman, Bell), Sudan II (Matheson, Coleman, Bell), Sudan IV (Matheson, Coleman, Bell), Sudan Orange G (Aldrich), Sudan Orange 220 (BASF), Paliogen Orange 3040 (BASF), Ortho Orange OR 2673 (Paul Uhlich), Paliogen Yellow 152, 1560 (BASF), Lithol Fast Yellow 0991K (BASF), Paliotol Yellow 1840 (BASF), Neopen Yellow (BASF), Novoperm Yellow FG 1 (Hoechst), Permanent Yellow YE 0305 (Paul Uhlich), Lumogen Yellow D0790 (BASF), Sunsperse Yellow YHD 6001 (Sun Chemicals), Suco-Gelb L1250 (BASF), Suco-Yellow D1355 (BASF), Hostaperm Pink E (American Hoechst), Fanal Pink D4830 (BASF), Cinquasia Magenta (DuPont), Lithol Scarlet D3700 (BASF), Toluidine Red (Aldrich), Scarlet for Thermoplast NSD PS PA (Ugine Kuhlmann of Canada), E.D. Toluidine Red (Aldrich), Lithol Rubine Toner (Paul Uhlich), Lithol Scarlet 4440 (BASF), Bon Red C (Dominion Color Company), Royal Brilliant Red RD-8192 (Paul Uhlich). Oracet Pink RF (Ciba-Geigy), Paliogen Red 3871K (BASF), Paliogen Red 3340 (BASF), Lithol Fast Scarlet L4300 (BASF), combinations of the foregoing and the like.

Wax

In addition to the polymer resin, the toners of the present disclosure also may contain a wax, which can be either a single type of wax or a mixture of two or more different waxes. A single wax can be added to toner formulations, for example, to improve particular toner properties, such as, toner particle shape, presence and amount of wax on the toner particle surface, charging and/or fusing characteristics, gloss, stripping, offset properties and the like. Alternatively, a combination of waxes can be added to provide multiple properties to the toner composition.

When included, the wax may be present in an amount of, for example, from about 1 wt % to about 25 wt % of the toner particles, in embodiments, from about 5 wt % to about 20 wt % of the toner particles.

Waxes that may be selected include waxes having, for example, a weight average molecular weight of from about 500 to about 20,000, in embodiments from about 1,000 to about 10,000. Waxes that may be used include, for example, polyolefins, such as, polyethylene, polypropylene and polybutene waxes, such as, commercially available from Allied Chemical and Petrolite Corporation, for example POLYWAX™ polyethylene waxes from Baker Petrolite, wax emulsions available from Michaelman, Inc, and the Daniels Products Company, EPOLENE N-15™ commercially available from Eastman Chemical Products, Inc., and VISCOL 550-P™, a low weight average molecular weight polypropylene available from Sanyo Kasei K. K.; plant-based waxes, such as, carnauba wax, rice wax, candelilla wax, sumacs wax and jojoba oil; animal-based waxes, such as, beeswax; mineral-based waxes and petroleum-based waxes, such as, montan wax, ozokerite, ceresin, paraffin wax, microcrystalline wax and Fischer-Tropsch wax; ester waxes obtained from higher fatty acid and higher alcohol, such as, stearyl stearate and behenyl behenate; ester waxes obtained from higher fatty acid and monovalent or multivalent lower alcohol, such as, butyl stearate, propyl oleate, glyceride monostearate, glyceride distearate, pentaerythritol tetra behenate; ester waxes obtained from higher fatty acid and multivalent alcohol multimers, such as, diethyleneglycol monostearate, dipropyleneglycol distearate, diglyceryl distearate and triglyceryl tetrastearate; sorbitan higher fatty acid ester waxes, such as, sorbitan monostearate, and cholesterol higher fatty acid ester waxes, such as, cholesteryl stearate. Examples of functionalized waxes that may be used include, for example, amines, amides, for example, AQUA SUPERSLIP 6550™ and SUPERSLIP 6530™ available from Micro Powder Inc., fluorinated waxes, for example, POLYFLUO 190™, POLYFLUO 200™. POLYSILK 19™ and POLYSILK 14™ available from Micro Powder Inc., mixed fluorinated, amide waxes, for example, MICROSPERSION 19™ available from Micro Powder Inc., imides, esters, quaternary amines, carboxylic acids or acrylic polymer emulsion, for example JONCRYL 74™, 89™, 130™, 537™ and 538™, all available from SC Johnson Wax, and chlorinated polypropylenes and polyethylenes available from Allied Chemical and Petrolite Corporation and SC Johnson wax. Mixtures and combinations of the foregoing waxes also may be used in embodiments. Waxes may be included as, for example, fuser roll release agents.

Toner Preparation

The toner particles may be prepared by any method within the purview of one skilled in the art. Although embodiments relating to toner particle production are described below with respect to emulsion-aggregation processes, any suitable method of preparing toner particles may be used, including chemical processes, such as suspension and encapsulation processes disclosed in U.S. Pat. Nos. 5,290,654 and 5,302,486, the disclosure of each of which hereby is incorporated by reference in entirety. In embodiments, toner compositions and toner particles may be prepared by aggregation and coalescence processes in which smaller-sized resin particles are aggregated to the appropriate toner particle size and then coalesced to achieve the final toner particle shape and morphology.

In embodiments, toner compositions may be prepared by emulsion-aggregation processes, such as, a process that includes aggregating a mixture of an optional wax and any other desired or required additives, and emulsions including the resins described above, optionally with surfactants, as described above, and then coalescing the aggregate mixture. A mixture may be prepared by adding an optional wax or other materials, which optionally also may be in a dispersion(s) including a surfactant, to the emulsion, which may be a mixture of two or more emulsions containing the resin. The pH of the resulting mixture may be adjusted by an acid (i.e., a pH adjustor) such as, for example, acetic acid, nitric acid or the like. In embodiments, the pH of the mixture may be adjusted to from about 2 to about 4.5. Additionally, in embodiments, the mixture may be homogenized. If the mixture is homogenized, homogenization may be accomplished by mixing at about 600 to about 4,000 revolutions per minute (rpm). Homogenization may be accomplished by any suitable means, including, for example, with an IKA ULTRA TURRAX T50 probe homogenizer or a Gaulin 15MR homogenizer.

Following preparation of the above mixture, an aggregating agent may be added to the mixture. Suitable aggregating agents include, for example, aqueous solutions of a divalent cation or a multivalent cation material. The aggregating agent may be, for example, polyaluminum halides, such as, polyaluminum chloride (PAC), or the corresponding bromide, fluoride or iodide, polyaluminum silicates, such as, polyaluminum sulfosilicate (PASS), and water soluble metal salts including aluminum chloride, aluminum nitrite, aluminum sulfate, potassium aluminum sulfate, calcium acetate, calcium chloride, calcium nitrite, calcium oxylate, calcium sulfate, magnesium acetate, magnesium nitrate, magnesium sulfate, zinc acetate, zinc nitrate, zinc sulfate, zinc chloride, zinc bromide, magnesium bromide, copper chloride, copper sulfate, and combinations thereof. In embodiments, the aggregating agent may be added to the mixture at a temperature that is below the glass transition temperature (T_{g}) of the resin.

The aggregating agent may be added to the mixture to form a toner in an amount of, for example, from about 0.1 parts per hundred (pph) to about 1 pph, in embodiments, from about 0.25 pph to about 0.75 pph.

The gloss of a toner may be influenced by the amount of retained metal ion, such as, Al³⁺, in the particle. The amount of retained metal ion may be adjusted further by the addition of ethylene diamine tetraacetic acid (EDTA). In embodiments, the amount of retained metal ion, for example. Al³⁺, in toner particles of the present disclosure may be from about 0.1 pph to about 1 pph, in embodiments, from about 0.25 pph to about 0.8 pph.

The disclosure also provides a melt mixing process to produce low cost and safe cross-linked thermoplastic binder resins for toner compositions which have, for example, low fix temperature and/or high offset temperature, and which may show minimized or substantially no vinyl offset. In the process, unsaturated base polyester resins or polymers are melt blended, that is, in the molten state under high shear conditions producing substantially uniformly dispersed toner constituents, and which process provides a resin blend and toner product with optimized gloss properties (see. e.g., U.S. Pat. No. 5,556,732, herein incorporated by reference in entirety). By, “highly cross-linked,” is meant that the polymer involved is substantially cross-linked, that is, equal to or above the gel point. As used herein, “gel point,” means the point where the polymer is no longer soluble in solution (see, e.g., U.S. Pat. No. 4,457,998, herein incorporated by reference in entirety).

To control aggregation and coalescence of the particles, in embodiments, the aggregating agent may be metered into the mixture over time. For example, the agent may be metered into the mixture over a period of from about 5 to about 240 min, in embodiments, from about 30 to about 200 min. Addition of the agent ma, also be done while the mixture is maintained under stirred conditions, in embodiments from about 50 rpm to about 1.000 rpm, in embodiments, from about 100 rpm to about 500 rpm, and at a temperature that is below the T_{g} of the resin.

The particles may be permitted to aggregate until a predetermined desired particle size is obtained. A predetermined desired size refers to the desired particle size as determined prior to formation, with particle size monitored during the growth process as known in the art until such particle size is achieved. Samples may be taken during the growth process and analyzed, for example with a Coulter Counter, for average particle size. The aggregation thus may proceed by maintaining the elevated temperature, or slowly raising the temperature to, for example, from about 40° C. to about 100° C., and holding the mixture at that temperature for a time from about 0.5 hr to about 6 hr, in embodiments, from about 1 hr to about 5 hr, while maintaining stirring, to provide the aggregated particles. Once the predetermined desired particle size is obtained, the growth process is halted. In embodiments, the predetermined desired particle size is within the toner particle size ranges mentioned above. In embodiments, the particle size may be about 5.0 to about 6.0 μm, about 6.0 to about 6.5 μm, about 6.5 to about 7.0 μm, about 7.0 to about 7.5 μm.

Growth and shaping of the particles following addition of the aggregation agent may be accomplished under any suitable conditions. For example, the growth and shaping may be conducted under conditions in which aggregation occurs separate from coalescence. For separate aggregation and coalescence stages, the aggregation process may be conducted under shearing conditions at an elevated temperature, for example from about 40° C. to about 90° C., in embodiments, from about 45° C. to about 80° C. which may be below the T_{g} of the resin.

Follow ing aggregation to the desired particle size, with the optional formation of a shell as described above, the particles then may be coalesced to the desired final shape, the coalescence being achieved by, for example, heating the mixture to a temperature of from about 55° C. to about 100° C., in embodiments from about 65° C. to about 75° C., which may be below the melting point of a crystalline resin to prevent plasticization. Higher or lower temperatures may be used, it being understood that the temperature is a function of the resins used.

Coalescence may proceed over a period of from about 0.1 to about 9 hr, in embodiments, from about 0.5 to about 4 hr.

After coalescence, the mixture may be cooled to room temperature, such as from about 20° C. to about 25° C. The cooling may be rapid or slow, as desired. A suitable cooling method may include introducing cold water to a jacket around the reactor. After cooling, the toner particles optionally may be washed with water and then dried. Drying may be accomplished by any suitable method, for example, freeze drying.

Toners may possess favorable charging characteristics when exposed to extreme RH conditions. The low humidity zone (C zone) may be about 12° C./15% RH, while the high humidity zone (A zone) may be about 28° C./85% RH. Toners of the disclosure may possess a parent toner charge per mass ratio (Q/M) of from about −5 μC/g to about −80 μC/g, in embodiments, from about −10 μC/g to about −70 μC/g, and a final toner charging after surface additive blending of from −15 μC/g to about −60 μC/g, in embodiments, from about −20 μC/g to about −55 μC/g.

Shell Resin

In embodiments, a shell may be applied to the formed aggregated toner particles. Any resin described above as suitable for the core resin may be utilized as the shell resin. The shell resin may be applied to the aggregated particles by any method within the purview of those skilled in the art. In embodiments, the shell resin may be in an emulsion including any surfactant described herein. The aggregated particles described above may be combined with said emulsion so that the resin forms a shell over the formed aggregates. In embodiments, an amorphous polyester may be utilized to form a shell over the aggregates to form toner particles having a core-shell configuration.

Toner particles can have a size of diameter of from about 4 to about 8 μm, in embodiments, from about 5 to about 7 μm, the optimal shell component may be about 26 to about 30% by weight of the toner particles.

Alternatively, a thicker shell may be desirable to provide desirable charging characteristics due to the higher surface area of the toner particle. Thus, the shell resin may be present in an amount from about 30% to about 40% by weight of the toner particles, in embodiments, from about 32% to about 38% by weight of the toner particles, in embodiments, from about 34% to about 36% by weight of the toner particles.

In embodiments, a photoinitiator may be included in the shell. Thus, the photoinitiator may be in the core, the shell, or both. The photoinitiator may be present in an amount of from about 1% to about 5% by weight of the toner particles, in embodiments, from about 2% to about 4% by weight of the toner particles.

Emulsions may have a solids loading of from about 5% solids by weight to about 20% solids by weight, in embodiments, from about 12% solids by weight to about 17% solids by weight.

Once the desired final size of the toner particles is achieved, the pH of the mixture may be adjusted with a base (i.e., a pH adjustor) to a value of from about 6 to about 10, and in embodiments from about 6.2 to about 7. The adjustment of the pH may be utilized to freeze, that is to stop, toner growth. The base utilized to stop toner growth may include any suitable base, such as, for example, alkali metal hydroxides, such as, for example, sodium hydroxide, potassium hydroxide, ammonium hydroxide, combinations thereof and the like. In embodiments, EDTA may be added to help adjust the pH to the desired values noted above. The base may be added in amounts from about 2 to about 25% by weight of the mixture, in embodiments, from about 4 to about 10% by weight of the mixture. In embodiments, the shell has a higher T_{g} than the aggregated toner particles.

Carriers

Various suitable solid core or particle materials can be utilized for the carriers and developers of the present disclosure. Characteristic particle properties include those that, in embodiments, will enable the toner particles to acquire a positive charge or a negative charge, and carrier cores that provide desirable flow properties in the developer reservoir present in an electrophotographic imaging apparatus. Other desirable properties of the core include, for example, suitable magnetic characteristics that permit magnetic brush formation in magnetic brush development processes; desirable mechanical aging characteristics; and desirable surface morphology to permit high electrical conductivity of any developer including the carrier and a suitable toner.

Examples of carrier particles or cores that can be utilized include iron and/or steel, such as, atomized iron or steel powders available from Hoeganaes Corporation or Pomaton S.p.A (Italy); ferrites, such as, Cu/Zn-ferrite containing, for example, about 11% copper oxide, about 19% zinc oxide, and about 70% iron oxide, including those commercially available from D. M. Steward Corporation or Powdertech Corporation. Ni/Zn-ferrite available from Powdertech Corporation, Sr (strontium)-ferrite, containing, for example, about 14% strontium oxide and about 86% iron oxide, commercially available from Powdertech Corporation, and Ba-ferrite; magnetites, including those commercially available from, for example, Hoeganaes Corporation (Sweden); nickel; combinations thereof, and the like. In embodiments, the polymer particles obtained can be used to coat carrier cores of any known type by various known methods, and which carriers then are incorporated with a known toner to form a developer for electrophotographic printing. Other suitable carrier cores are illustrated in, for example, U.S. Pat. Nos. 4,937,166, 4,935,326 and 7,014,971, the disclosure of each of which hereby is incorporated by reference in entirety, and may include granular zircon, granular silicon, glass, silicon dioxide, combinations thereof, and the like. In embodiments, suitable carrier cores may have an average particle size of, for example, from about 20 μm to about 400 μm in diameter, in embodiments, from about 40 μm to about 200 μm in diameter.

In embodiments, a ferrite may be utilized as the core, including a metal, such as, iron and at least one additional metal, such as, copper, zinc, nickel, manganese, magnesium, calcium, lithium, strontium, zirconium, titanium, tantalum, bismuth, sodium, potassium, rubidium, cesium, strontium, barium, yttrium, lanthanum, hafnium, vanadium, niobium, aluminum, gallium, silicon, germanium, antimony, combinations thereof and the like.

In some embodiments, the carrier coating may include a conductive component. Suitable conductive components include, for example, carbon black.

There may be added to the carrier a number of additives, for example, charge enhancing additives, including particulate amine resins, such as, melamine, and certain fluoropolymer powders, such as alkyl-amino acrylates and methacrylates, polyamides, and fluorinated polymers, such as polyvinylidine fluoride and poly(tetrafluoroethylene) and fluoroalkyl methacrylates, such as 2,2,2-trifluoroethyl methacrylate. Other charge enhancing additives which may be utilized include quaternary ammonium salts, including distearyl dimethyl ammonium methyl sulfate (DDAMS), bis[1-(3,5-disubstituted-2-hydroxyphenyl)azo]-3-(mono-substituted)-2-naphthalenolato(2-)]chromate(1-), ammonium sodium and hydrogen (TRH), cetyl pyridinium chloride (CPC), FANAL PINK® D4830, combinations thereof, and the like, and other effective known charge agents or additives. The charge additive components may be selected in various effective amounts, such as from about 0.5 wt % to about 20 wt %, from about 1 wt % to about 3 wt %, based, for example, on the sum of the weights of polymer/copolymer, conductive component, and other charge additive components. The addition of conductive components can act to further increase the negative triboelectric charge imparted to the carrier, and therefore, further increase the negative triboelectric charge imparted to the toner in, for example, an electrophotographic development subsystem. The components may be included by roll mixing, tumbling, milling, shaking, electrostatic powder cloud spraying, fluidized bed, electrostatic disc processing, and an electrostatic curtain, as described, for example, in U.S. Pat. No. 6,042,981, the disclosure of which hereby is incorporated by reference in entirety, and wherein the carrier coating is fused to the carrier core in either a rotary kiln or by passing through a heated extruder apparatus.

Conductivity can be important for semiconductive magnetic brush development to enable good development of solid areas which otherwise may be weakly developed. Addition of a polymeric coating of the present disclosure, optionally with a conductive component such as carbon black, can result in carriers with decreased developer triboelectric response with change in relative humidity of from about 20% to about 90%, in embodiments, from about 40% to about 80%, that the charge is more consistent when the relative humidity is changed. Thus, there is less decrease in charge at high relative humidity reducing background toner on the prints, and less increase in charge and subsequently less loss of development at low relative humidity, resulting in such improved image quality performance due to improved optical density.

As noted above, in embodiments the polymeric coating may be dried, after which time it may be applied to the core carrier as a dry powder. Powder coating processes differ from conventional solution coating processes. Solution coating requires a coating polymer whose composition and molecular weight properties enable the resin to be soluble in a solvent in the coating process. That requires relatively low M_{w} components as compared to powder coating. The powder coating process does not require solvent solubility, but does require the resin coated as a particulate with a particle size of from about 10 nm to about 2 μm, in embodiments, from about 30 nm to about 1 μm, in embodiments, from about 50 nm to about 500 nm.

Examples of processes which may be utilized to apply the powder coating include, for example, combining the carrier core material and resin coating by cascade roll mixing, tumbling, milling, shaking, electrostatic powder cloud spraying, fluidized bed, electrostatic disc processing, electrostatic curtains, combinations thereof and the like. When resin coated carrier particles are prepared by a powder coating process, the majority of the coating materials may be fused to the carrier surface, thereby reducing the number of toner impaction sites on the carrier. Fusing of the polymeric coating may occur by mechanical impaction, electrostatic attraction, combinations thereof and the like.

Following application of the resin to the core, heating may be initiated to permit flow of the coating material over the surface of the carrier core. The concentration of the coating material, in embodiments, powder particles, and the parameters of the heating may be selected to enable the formation of a continuous film of the coating polymers on the surface of the carrier core, or permit only selected areas of the carrier core to be coated. In embodiments, the carrier with the polymeric powder coating may be heated to a temperature of from about 170° C. to about 280° C., in embodiments from about 190° C. to about 240° C., for a period of time of, for example, from about 10 min to about 180 min, in embodiments, from about 15 min to about 60 min, to enable the polymer coating to melt and to fuse to the carrier core particles. Following incorporation of the powder on the surface of the carrier, heating may be initiated to permit flow of the coating material over the surface of the carrier core. In embodiments, the powder may be fused to the carrier core in either a rotary kiln or by passing through a heated extruder apparatus, see, for example, U.S. Pat. No. 6,355,391, the disclosure of which hereby is incorporated by reference in entirety.

In embodiments, the coating coverage encompasses from about 10% to about 100% of the carrier core. When selected areas of the metal carrier core remain uncoated or exposed, the carrier particles may possess electrically conductive properties when the core material is a metal.

The coated carrier particles may then be cooled, in embodiments to room temperature, and recovered for use in forming developer.

In embodiments, carriers of the present disclosure may include a core, in embodiments, a ferrite core, having a size of from about 20 μm to about 100 μm, in embodiments, from about 30 μm to about 75 μm, coated with from about 0.5% to about 10% by weight, in embodiments, from about 0.7% to about 5% by weight, of the polymer coating of the present disclosure, optionally including carbon black.

Thus, with the carrier compositions and processes of the present disclosure, there can be formulated developers with selected high triboelectric charging characteristics and/or conductivity values utilizing a number of different combinations.

Developers

The toner particles thus formed may be formulated into a developer composition. The toner particles may be mixed with carrier particles to achieve a two component developer composition. The toner concentration in the developer may be from about 1% to about 25% by weight of the total weight of the developer, in embodiments, from about 2% to about 15% by weight of the total weight of the developer.

Imaging

The toners can be utilized for electrophotographic processes, including those disclosed in U.S. Pat. No. 4,295,990, the disclosure of which is hereby incorporated by reference in entirety. In embodiments, any known type of image development system may be used in an image developing device, including, for example, magnetic brush development, hybrid scavengeless development (HSD) and the like. Those and similar development systems are within the purview of those skilled in the art.

It is envisioned that the toners of the present disclosure may be used in any suitable procedure for forming an image with a toner, including in applications other than xerographic applications.

Utilizing the toners of the present disclosure, images may be formed on substrates, including flexible substrates, having a toner pile height of from about 1 μm to about 6 μm, in embodiments, from about 2 μm to about 4.5 μm, in embodiments, from about 2.5 to about 4.2 μm.

In embodiments, the toner of the present disclosure may be used for a xerographic print protective composition that provides overprint coating properties including, but not limited to, thermal and light stability and smear resistance, particularly in commercial print applications. More specifically, such overprint coating as envisioned has the ability to permit overwriting, reduce or prevent thermal cracking, improve fusing, reduce or prevent document offset, improve print performance and protect an image from sun, heat and the like. In embodiments, the overprint compositions may be used to improve the overall appearance of xerographic prints due to the ability of the compositions to fill in the roughness of xerographic substrates and toners, thereby forming a level film and enhancing glossiness.

The following Examples are submitted to illustrate embodiments of the disclosure. The Examples are intended to be illustrative only and are not intended to limit the scope of the disclosure. Also, parts and percentages are by weight unless otherwise indicated. As used herein, “room temperature,” refers to a temperature of from about 20° C. to about 30° C.

### EXAMPLES

The examples set forth herein below are being submitted to illustrate embodiments of the present disclosure. These examples are intended to be illustrative only and are not intended to limit the scope of the present disclosure. Also, parts and percentages are by weight unless otherwise indicated. Comparative examples and data are also provided.

### Example 1

### Synthesis of Poly(1-octadecene)

Anhydrous toluene (available as 244511 from Sigma-Aldrich; St. Louis, Mo.) was used as received or else technical grade toluene may be dried over sodium and distilled before use. The catalyst rac-Et(Ind)₂ZrCl₂ (Dichloro[rac-ethylenebis(indenyl)]zirconium(IV) (available as 393231 from Sigma-Aldrich) and cocatalyst methylaluminoxane (MAO) 10 weight percent in toluene (available as 404594 from Sigma-Aldrich) were used as received. Polymerization was done under a dry nitrogen atmosphere in a 1 L round bottom flask equipped with an oval stir bar in a temperature-controlled silicone oil bath. The ratio for the reaction is 30,000:1000:1 as monomer to MAO to metallocene.

The polymerization process was as follows: 500 g of toluene and 50 g of MAO (0.086M in toluene) were charged into flask via cannulation using a double-sided needle. This reaction mixture was saturated with 200 g 1-octadecene (available as 0806 from Sigma-Aldrich). Lastly, the catalyst solution of approximately 37 g (0.023 g/0.055 mmole in 37 g toluene) or rac-Et(Ind)₂ZrCl₂ was added to flask via cannulation to start the polymerization reaction. The rpm of the reaction was 500 and constantly blanketed with N₂. The middle joint of the glass flask was connected to a condenser attached to a bubbler. After 60 minutes at 70° C., the reaction was terminated by the addition of 1.5 L of acidified methanol (2 wt. % HCl in methanol). The polymer was isolated by filtration and washed with methanol before drying in a vacuum oven over the weekend at about 40-50° C. The synthesis scheme is shown below.

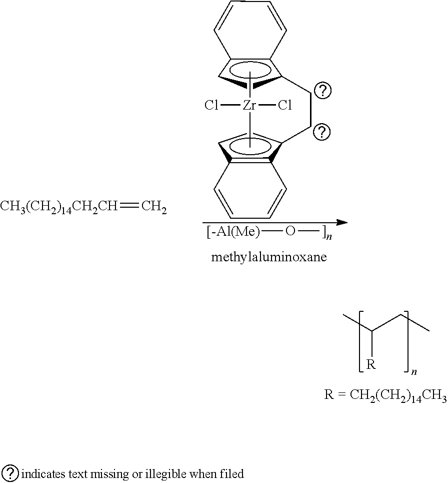

Dispersion of Poly(1-octadecene) wax (PP-EAWAX-161)

The equipment, including a Gaulin 15MR homogenizer (available from APV Homogenizer Group; Wilmington, Mass.), 1 US gal stainless steel reactor and circulation system is needed which can operate at above atmospheric pressure.

In a 4 L plastic beaker, 60.2 g of Tayca power surfactant is dissolved in 2517 g of de-ionized water (DIW). Once the surfactant is dissolved in the water; the surfactant water solution is added to the 1 gal reactor equipment with a re-circulating loop and in-line piston Gaulin 15-MR homogenizer followed by 722 g of poly(1-octadecene) (VF(5-P10D) with a Mw of 19.3 k, Mn 3.1 k, polydispersity (PD) 6.4 and melting point (mpt) 65° C.). The charge ports and vents are closed so that the reactor is isolated from the environment. The agitator is turned on at 500 rpm and the reactor jacket is heated to 120° C.

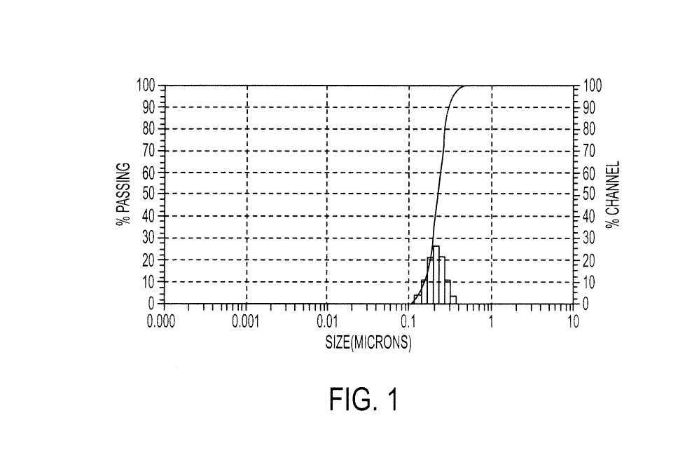

When the reactor contents reach 120° C., mixing is allowed to continue for 5 minutes at which point homogenization commences. To commence homogenization, the bottom valve of the reactor is opened and the Gaulin 15-MR homogenizer is turned on. The first 20 minutes of homogenization occur at low pressure by setting the secondary stage of the homogenizer to approximately 800 psi. Once complete, the next 45 minutes of homogenization occur at high pressure. With the secondary stage still set to 800 psi, the primary stage is set to 7000 psi. During this time the pressure in the reactor reaches approximately 100-200 kPa due to the fact that it is sealed. After 45 min of high pressure homogenization, the homogenizer pressure is decreased to 0 psi and turned off and the mixture is cooled to room temperature. The reactor is vented and the resulting dispersion is filtered through a 100 micron nylon filter. Approximately 3000 g of the final dispersion is produced containing 18% solids, and has a particle size of 229 nm as measured by the Nanotrac (available from Microtrac; Montgomeryville, Pa.), as shown in FIG. 1.

The resulting dispersion was then used to make an EA toner.

Preparation of Control Toner 1 (Emulsion Aggregation High Gloss (EAHG)) and Example Toners 1-5

Two twenty gallon scale samples and five bench scale samples were submitted for fusing evaluation. The purpose was to 1) determine the initial fusing performance for a control EA toner particles made with paraffin wax that were continuously coalesced and 2) determine the initial fusing performance for various combinations of shell/core latex and additives. Gloss, crease and hot offset data of particles was collected with samples fused onto Color Xpressions Select (90 gsm) using an in-house fusing fixture.

Control Toner 1

Continuously coalesced 20-gallon scale EA toner particles and paraffin wax particles:

Cyan and black low melt particles (Pilot Toners 1 and 2) that were continuously coalesced with pilot scale apparatus show a shift in crease fix MFT to lower fuser roll temperatures. The shift is consistent with previous results for particles made with paraffin wax and continuous coalescence process. Crease fix MFT's are still greater than production particles of Control Toner 2.

Gloss curves are nearly identical for both Pilot Toners 1 and 2 (low melt) particles and are similar to standard production Control Toner 1. The gloss curves require a significantly higher fuser roll temperature when compared to the Control Toner 2 and is consistent with earlier results.

Replacing IGI wax used in the current EAHG design with paraffin wax shifts crease fix MFT to slightly lower temperatures and continuously coalescing the particles reduces crease fix MFT again. However gloss does not shift to a lower fuser temperature so print gloss for Pilot Toners 1-2 will be less than Control Toner 2 toner print gloss.

Control Toner 2

An emulsion aggregation polyester toner was prepared at a 2 liter (2 L) Bench scale (about 165 grams of dry theoretical toner). About 110 grams of a linear amorphous resin, referred to herein as resin A in an emulsion (about 38 weight % resin) and about 111 grams of a linear amorphous resin, referred to herein as resin B in an emulsion (about 37 weight % resin), about 34 grams of a crystalline polyester emulsion, about 5.06 grams of surfactant (i.e., DOWFAX®, commercially available from the Dow Chemical Company), about 58 grams of a cyan pigment, Pigment Blue 15:3 in a dispersion (about 17 weight %), and about 51 grams of a paraffin wax (about 30 weight %) (commercially available from The International Group, Inc.), were added to a plastic beaker and mixed. The pH of the mixture was adjusted to about 4.2 by adding about 22 grams of nitric acid (about 0.3M). About 2.96 grams of Al2(SO4)3 (about 27.8 weight %) mixed with about 36.5 grams of deionized water was added to the slurry as a flocculent under homogenization at a speed of from about 3000 rpm to about 4000 rpm for about 5 minutes. The slurry was then transferred to a 2 L Buchi reactor.

The mixture was subsequently heated to about 42° C., for aggregation while mixing at a speed of about 460 rpm.

When the particle size reached a certain value, for example about 5 μm, a mixture of about 60 grams of the same linear amorphous resin A in an emulsion described above (about 38 weight % resin) and about 61 grams of the same linear amorphous resin B in an emulsion described above (about 37 weight % resin) were added to the reactor to form a shell over the aggregated particles. The batch was further heated at about 45° C. to achieve the desired particle size. The pH of the mixture was adjusted to about 5 by adding about 11.4 grams of pH 9 Tris-HCL buffer, sodium hydroxide, and EDTA. Once at the target particle size of about 5.5 microns was obtained (i.e. after about 1 hour), the aggregation step was frozen.

The reactor temperature was then increased to about 85° C., and the pH was adjusted to about 6.5 using pH 5.7 sodium acetate/acetic acid buffer, so that the particles began to coalesce. After about two hours, the particles achieved >0.965 circularity as determined by FPIA, and were cooled.

The particle size was monitored with a Coulter Counter and the Geometric Size Distribution (“GSD”) was determined. The final toner particle size, GSDv, and GSDn were about 5.48 μm, about 1.21, and about 1.24, respectively. The fines (about 1-4 microns), coarse (about >16 microns), and circularity of the resulting particles were about 18.63%, about 0.2% and about 0.969, respectively.

Example Toners 1-5

Type and amount of latex in shell and core were varied as well as adding different additives:

A 40° C. Tg core and EP02+gel shell resulted in a crease fix MFT that approached production Control Toner 2 particle crease fix MFT but print gloss was comparable to Control Toner 1.

EP08 latex in the core and shell did not lower crease fix MFT significantly and produced a less glossy toner which is consistent to earlier work.

EP07 latex in the core and EP06 latex in the shell resulted in a lower crease fix MFT. The reduction in MFT was comparable to that found when EP08 latex is used in the shell. Print gloss is shifted to a higher fuser roll temperature and is similar to that found when EP08 is used in the shell.

Increasing the amount of EP08 used in the shell layer did not lower crease fix further when compared to EP08 used with the nominal amount of shell latex.

The addition of polyoctadecence into particles using EP07 latex as the core, EP02 latex as the shell and paraffin wax did not result in further reduction in MFT. Prints were less glossy than Control Toner 1.

All the above samples used 1% paraffin wax (N539) as the release agent.

Preparation of Example Toner 5 with Additive (Black Toner with 10% Poly (1-Octadecene) Wax Dispersion)

In a 2 L glass reactor, 170 grams of a latex emulsion comprised of polymer particles generated from the emulsion polymerization of styrene, butyl acrylate and beta carboxy ethyl acrylate (β-CEA) (EP07, 41% solids, Table 1), 58 grams of aqueous paraffin wax dispersion (lot. Paraffin N-539, 30% solids), 58 grams of Black pigment dispersion (lot. Nipex-35, 17.5% solids). 10 grams of Cyan pigment dispersion (lot Sun PB15-3, 16% solids), and 86 grams of the poly(1-octadecene) wax dispersion (lot. PP-EAWAX-161, 18% solids) are added to about 482 grams of deionized water and the slurry is then homogenized using an IKA ULTRA TURRAXΔ T50 homogenizer operating at about 3,000-4,000 revolutions per minute (rpm).

During homogenization about 28 grams of a flocculent mixture containing about 2.8 grams polyaluminum chloride mixture and about 25.2 grams 0.02 molar nitric acid solution is added to the slurry. Thereafter, the 2 L glass reactor is transferred to a heating mantle; the rpm is set to 230 and heated to a temperature of about 50° C. where samples are taken to determine the average toner particle size. Once the particle size of about 4.8 microns as measured with a Coulter Counter is achieved, 106 grams of latex emulsion (EP02, 41% solids, Table 1) similar to that in the core was added to the reactor over a 5 minute time span. The reactor is then heated to 52 C. When the toner particle size reaches 5.6-6 microns, freezing begins with the pH of the slurry being adjusted to 3.3 using a 4% NaOH solution. The reactor RPM is decreased to 220 followed by the addition of 3.74 g of a chelating agent (Versene100) and more NaOH solution until pH reaches 4.5. The reactor temperature is ramped to 96° C. Once at the coalescence temperature, the slurry is coalesced for about 1 hour until the particle circularity is between 0.955-0.960 as measured by the Flow Particle Image Analysis (FPIA) instrument. The slurry is then cooled. The final particle size was 5.54 microns. GSDv 1.19. GSDn 1.21 and a circularity of 0.957.

TABLE 1

| Latex Type | EP01/07* | EP02** |
|---|---|---|
| Styrene (%) | 76.5 | 81.7 |
| n-butyl acrylate (nBA) (%) | 23.5 | 18.3 |
| Particle Size (nm) | 170-240 | 170-240 |
| Mw (k) | 35 ± 3 | 35 ± −2 |
| Solids (%) | 41 ± −2 | 41 ± −2 |
| Tg (° C.) | 51 ± −2 | 60 ± −2 |

*different latex formulation codes for styrene acrylate latexes - 01 and 07 are the same formulations
**emulsion polymerization “02”

Preparation of Example Toner 5 without Additive (Black Toner Wax Dispersion)

An EA toner was prepared in the same manner as described above, however, the 10% poly (1-octadecene) was left out of this toner composition.

Preparation of Example 1 without Additive (Black Toner wax dispersions)

Pilot Toner 1 (Cyan Low Melt High Gloss Styrenic Toner)

In a 2 L glass reactor, 278 grams of a latex emulsion comprised of polymer particles generated from the emulsion polymerization of styrene, butyl acrylate and beta carboxy ethyl acrylate (β-CEA) (lot. SDC-EP07, 41% solids), 72 grams of aqueous wax dispersion (lot. IGI wax, 31% solids), and 64 grams of Cyan pigment dispersion (lot Sun PB15-3, 17% solids) are added to about 611 grams of deionized water and the slurry is then homogenized using an IKA ULTRA TURRAX T50 homogenizer operating at about 3,000-4,000 revolutions per minute (rpm). During homogenization about 28 grams of a flocculent mixture containing about 3.6 grams polyaluminum chloride mixture and about 32.4 grams 0.02 molar nitric acid solution is added to the slurry. Thereafter, the 2 L glass reactor is transferred to a heating mantle; the rpm is set to 230 and heated to a temperature of about 50° C. where samples are taken to determine the average toner particle size. Once the particle size of about 4.8-5 microns as measured with a Coulter Counter is achieved, 106 grams of latex emulsion (lot. SDC-EP02, 41% solids) similar to that in the core was added to the reactor over a 5 minute time span. The reactor is then heated to 52° C. When the toner particle size reaches 5.6-6 microns, freezing begins with the pH of the slurry being adjusted to 3.3 using a 4% NaOH solution. The reactor RPM is decreased to 220 followed by the addition of 3.74 grams of a chelating agent (Versene100) and more NaOH solution until pH reaches 4.5. The reactor temperature is ramped to 96 C. Once at the coalescence temperature, the slurry is coalesced for about 1 hour until the particle circularity is between 0.955-0.960 as measured by the Flow Particle Image Analysis (FPIA) instrument. The slurry is then cooled.

Pilot Toner 2 (Black Low Melt High Gloss Styrenic Toner)

Pilot Toner 2 was prepared in the same way as Pilot Toner 1 except that carbon black is used as the colorant instead of cyan.

Fusing of Example Toners and Control Toners

Procedure

The particles submitted for fusing evaluation were blended with additives from the control EA toner using the lab scale SKM mill (12500 rpm for 30 seconds). The Control Toner 1 was supplied with external additives already blended onto the surface and produced good quality unfused images for gloss/crease and hot offset samples. The Control Toner 1 is used to confirm that the fusing fixture performance is consistent. Good quality images were made for all samples when using their respective additive package and the Dnieper carrier for the developer.

All unfused images were generated using a modified DC12 copier. A Toner Mass per unit Area (TMA) of 1.00 mg/cm2 was made on CXS paper (Color Xpressions Select, 90 gsm, uncoated, P/N 3R11540) and used for gloss, crease and hot offset measurements. Gloss/crease targets were a square image placed in the centre of the page. In general two passes (sometimes three passes) through the DC12 while adjusting developer bias voltage was required to achieve the desired TMA.

Samples were fused with an in-house fusing fixture. The fuser is a FBNF design (35 mm diameter fuser roll, three fuser lamps, heat insulators and belt roll). A production fuser CRU was fitted with an external motor and temperature control along with paper. Process speed of the fuser was set to 220 mm/s (nip dwell of ˜34 ms) and the fuser roll temperature was varied from cold offset to hot offset or up to 210° C. for gloss and crease measurements on the samples. After the set point temperature of the fuser roll has been changed, a ten minute wait time is allowed so that the temperature of the belt and pressure assembly can stabilize.

Test Results

Cold Offset

The Control Toner 1 started to cold offset at 133° C. The Example Toner 5 with additive started to cold offset at 127° C. and 130° C. The degree of cold offset varies depending on the particular sample.

Gloss

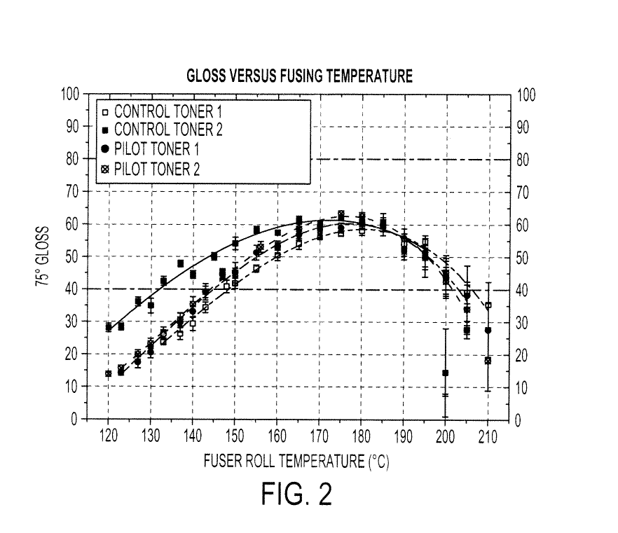

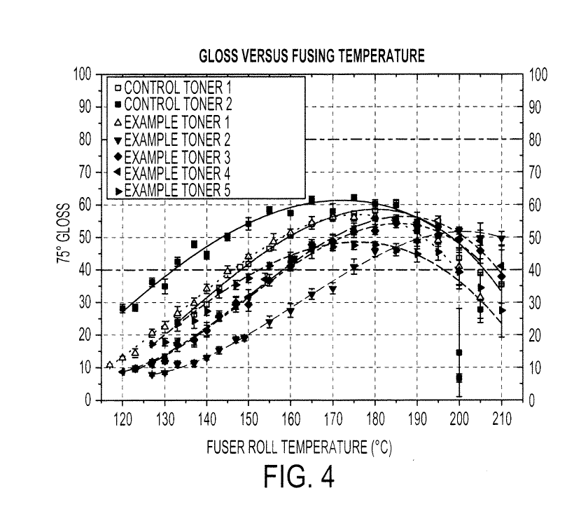

75° gloss curves are plotted in FIGS. 2 and 4, with the results summarized in Tables 2 and 3. As can be seen, the Control Toner required the fuser temperature to be 160° C. to reach 50 gu (TG₅₀) with a peak gloss of 58.

Peak print gloss for the two toners (LM-C1 & LM-K1) was ˜61 gu and required a fuser roll temperature of 155° C. to reach 50 gloss units, TG₅₀. Four out of the five bench samples had peak gloss between 52 gu and 57 gu and TG₅₀ between of 158° C. and 170° C. Example Toner 5 with additive did not reach 50 gloss units its peak was 48 gu.

A repeat test was done with the Example Toner 5 without additive. This toner also shows higher gloss peak.

TABLE 2

| | Control Toner 1 | | | |
|---|---|---|---|---|
| | Core = EP07, | | | |
| | Shell = EP02 | | | |
| | IGI wax | Control Toner 2 | Pilot Toner 1 | Pilot Toner 2 |
| Fused | April 26/13 | April 26/13 | April 26/13 | April 26/13 |
| Reactor | 6000 gallon | 6000 gallon | 20 gallon | 20 gallon |
| Shell Latex (28%) | EP02 | EP33/EP34 | EP02 | EP02 |
| Core Latex (28%) | EP07 | EP33/EP34 + 6.8% | EP07 | EP07 |
| | | CPE | | |
| Wax: | 11.0% IGI wax | 9.0% IGI | 11.0% N539 | 11.0% N539 |
| Pigment: | 5.5% Sun PB15:3 | 5.5% Sun PB15:3 | 5.5% Sun PB15:3 | 6.0% Nipex 35 |
| | | | | 0.64% Sun PB15:3 |
| Particle Tg (onset) | | | 47 | 48 |
| Particle Al (ppm) | | | 291 | 211 |
| D50 (microns)/GSDv/GSDn) | ~5.8 | ~5.8 | ? | ? |
| Cold offset on CX+* | 133 | 120 | 123 | 123 |
| Gloss at MFT on CX+ | 30.0 | 27.1 | 23.7 | 20.0 |
| Gloss at 185° C. on CX+ | 58.0 | 58.6 | 58.6 | 60.2 |
| Peak Gloss on CX+ | 58.5 | 61.3 | 60.4 | 62.5 |
| T(Gloss 40) on CX+ | 148 | 132 | 145 | 144 |
| T(Gloss 50) on CX+ | 160 | 144 | 155 | 154 |
| MFT_{CA=80} (extrapolated | 139 | 120 | 131 | 127 |
| MFT)** | | | | |
| ΔMFT | 0 | −19 | −8 | −12 |
| (Relaiive to Control Toner 1 | | | | |
| fused the same day) | | | | |
| Mottle/Hot Offset | 200/210 | 195/200 | 195/205 | 195/200 |
| CX + 220 mm/s | | | | |
| Fusing Latitude | 61/71 | 75/80 | 64/74 | 68/73 |
| HO-MFT on DCX+*** | | | | |
| ΔFix (T_{G50} & | 0/+16 | −16/0 | −5/+11 | −6/+10 |
| MFT_{CA=80})**** | | | | |
| Control Toner 1/Control | | | | |
| Toner 2 | | | | |
| Leave out since we have no | | | | |
| results | | | | |

TABLE 3

| | Example Toner 1 | | | | Example Toner 5 |
|---|---|---|---|---|---|
| | Core: VF745 | Example Toner 2 | Example Toner 3 | Example Toner 4 | Core: EP07 + |
| | Shell: EP02 + | Core: EP08 | Core: EP07 | Core: EP07 | 10% POD |
| | EP03 | Shell: EP08 | Shell: EP08 | 40% Shell: EP08 | Shell: EP02 |
| Fused | April 26/13 | April 26/13 | April 26/13 | April 26/13 | April 26/13 |
| Reactor | 2 L Buchi | 2 L Buchi | 2 L Buchi | 2 L Buchi | 2 L Buchi |
| Shell Latex (28%) | EP02 + EP03 | EPO8 | EP06 | 40% EP08 | EP02 |
| Core Latex (28%) | VF745 | EP08 | EP07 | EP07 | EP07 + |
| | | | | | polyoctadecene |
| Wax: | 11.0% N539 | 11.0% N539 | 11.0% N539 | 11.0% N539 | 11.0% N539 |
| Pigment: | 6.0% Nipex 35 | 6.0% Nipex 35 | 6.0% Nipex 35 | 6.0% Nipex 35 | 6.0% Nipex 35 |
| | 0.64% Sun PB15:3 | 0.64% Sun PB15:3 | 0.64% Sun PB15:3 | 0.64% Sun PB15:3 | 0.64% Sun PB15:3 |
| Particle Tg (onset) | | | | | |
| Particle Al (ppm) | | | | | |
| D50 (microns)/GSDv/GSDn | 6.48/1.27/1.28 | 5.71/1.23/12.5 | 6.28/1.24/1.24 | 5.77/1.19/1.20 | 5.54/1.23/1.25 |
| Cold offset on CX+ | 120 | 127 | 123 | 123 | 130 |
| Gloss at MFT on CX+ | 16.2 | 11.0 | 14.2 | 13.9 | 24.1 |
| Gloss at 185° C. on CX+ | 54.6 | 46.8 | 54.1 | 56.1 | 46.7 |
| Peak Gloss on CX+ | 56.9 | 51.5 | 54.1 | 56.2 | 48.4 |
| T(Gloss 40) on CX+ | 146 | 175 | 159 | 158 | 153 |
| T(Gloss 50) on CX+ | 158 | 192 | 172 | 170 | / |
| M_{CA=80} (extrapolated | 123 | 136 | 131 | 130 | 134 |
| MFT) | | | | | |
| ΔMFT | −16 | −3 | −8 | −9 | −5 |
| (Relative to Control Toner 1 | | | | | |
| fused the same day) | | | | | |
| Mottle/Hot Offset | 190/200 | >210/>210 | 200/210 | 200/>210 | 200/210 |
| CX + 220 mm/s | | | | | |
| Fusing Latitude | 67/77 | >74/>74 | 69/79 | 70/>80 | 66/76 |
| HO-MFT on DCX+ | | | | | |
| ΔFix (T_{G50} & MFT_{CA=8o}) | −2/+14 | +32/+48 | +12/+28 | +10/+26 | N/A |
| Control Toner 1/Control | | | | | |
| Toner 2 | | | | | |

*CX+ = paper utilized from Xerox Corporation
**MFT = minimum fusing temperature
***HO-MFT = Fusing Latitude = Hot Offset - MFT on CX + paper
****Δfix is the minimum fusing temperature required to reach 50 gloss units or a crease fix area of 80 relative to some control toner.

Mottle/Hot Offset is the temperature at which the toner will lift off the paper and stick to the fuser roll. T(Gloss 50) is the temperature at which the toner reaches 50 gloss units and T(Gloss 60) is the temperature at which the toner reaches 60 gloss units.

TABLE 4

| | Gloss Temp (° C.) | | | | | | Peak Gloss | COT | Mottle |
|---|---|---|---|---|---|---|---|---|---|
| Toner ID | T(G₃₀) | T(G₄₀) | T(G₅₀) | T(G₆₀) | T(G₇₀) | T(G₈₀) | Gₘₐₓ | (° C.) | (° C.) |
| Control | 139 | 148 | 160 | / | / | / | 58.5 | 133 | 200 |
| Toner 1 | | | | | | | | | |
| Control | 123 | 132 | 144 | 163 | 61.3 | / | 61.3 | 120 | 195 |
| Toner 2 | | | | | | | | | |
| Pilot | 136 | 145 | 155 | 173 | / | / | 60.4 | 123 | 195 |
| Toner 1 | | | | | | | | | |
| Pilot | 136 | 144 | 154 | 167 | / | / | 62.5 | 123 | 195 |
| Toner 2 | | | | | | | | | |
| Example | 136 | 146 | 158 | / | / | / | 56.9 | 120 | 190 |
| Toner 1 | | | | | | | | | |
| Example | 162 | 175 | 192 | / | / | / | 51.5 | 127 | >210 |
| Toner 2 | | | | | | | | | |
| Example | 149 | 159 | 172 | / | / | / | 54.1 | 123 | 200 |
| Toner 3 | | | | | | | | | |
| Example | 148 | 158 | 170- | / | / | / | 56.2 | 123 | 200 |
| Toner 4 | | | | | | | | | |
| Example | 140 | 153 | / | / | / | / | 48.4 | 130 | 200 |
| Toner 5 | | | | | | | | | |

| | HOT | | Temp. | dLogCA | | | |
|---|---|---|---|---|---|---|---|
| | (° C.) | Crease | (° C.) | dT | Δ | | |
| Toner ID | 220 mm/s | T(C₈₀) | T(C₄₀) | (° C.⁺¹) | (C₈₀) | FC(80) | FC(40) |
| Control | 210 | 139 | 146 | −0.0496 | / | 2.07 | 1.85 |
| Toner 1 | | | | | | | |
| Control | 200 | 120 | 123 | −0.1322 | −19 | 2.03 | 1.70 |
| Toner 2 | | | | | | | |
| Pilot | 205 | 131 | 135 | −0.0675 | −8 | 2.09 | 1.74 |
| Toner 1 | | | | | | | |
| Pilot | 200 | 127 | 132 | −0.0563 | −12 | 2.26 | 1.88 |
| Toner 2 | | | | | | | |
| Example | 200 | 123 | 127 | −0.0710 | −16 | 2.16 | 1.84 |
| Toner 1 | | | | | | | |
| Example | >210 | 136 | 142 | −0.0501 | −3 | 2.01 | 1.53 |
| Toner 2 | | | | | | | |
| Example | 210 | 131 | 135 | −0.0733 | −8 | 2.14 | 1.82 |
| Toner 3 | | | | | | | |
| Example | >210 | 130 | 135 | −0.0623 | −9 | 2.11 | 1.66 |
| Toner 4 | | | | | | | |
| Example | 210 | 134 | 140 | −0.0487 | −5 | 2.42 | 2.13 |
| Toner 5 | | | | | | | |

Crease

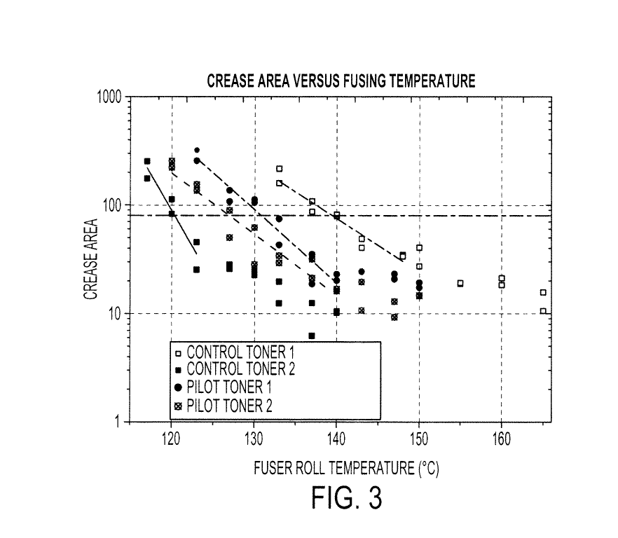

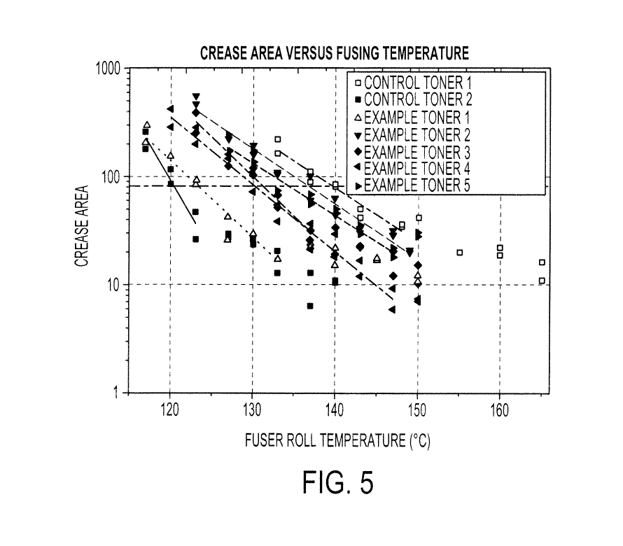

Crease area measurements are carried out with an in-house image analysis system and a BYK Gardner 75° gloss meter used to measure print gloss as a function of fuser roll temperature. Plots of crease area as a function of fuser roll temperature are shown in FIGS. 3 and 5 with the results summarized Tables 2-4. As can be seen, the Control Toner required the fuser temperature to be 139° C. to reach MFT_{CA=80}.

Long term trends in fusing results for Control Toner 1 are in Table 5. Three of the low melt samples (Example Toners 2-4) had crease fix MFT's of ˜131° C. Example Toners 2 and 5 crease fix MFT's were ˜135° C. The MFT's for two samples (Pilot Toner 2 and Example Toner 1) were 127° C. and 123° C.

Hot Offset/Fusing Latitude

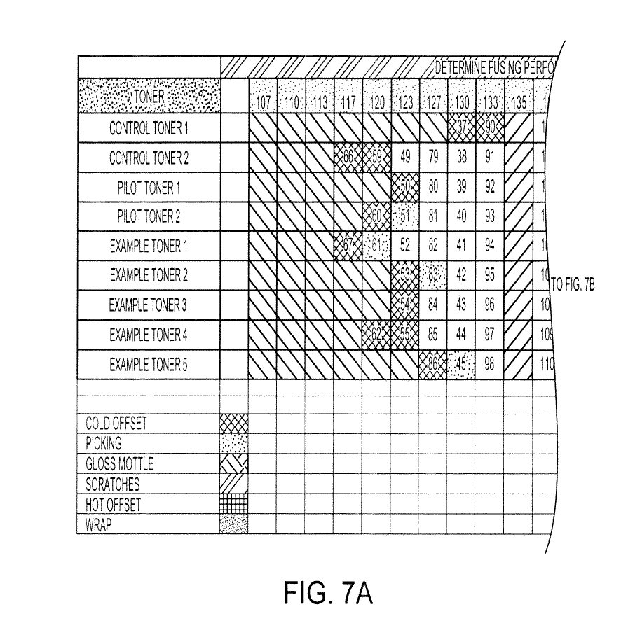

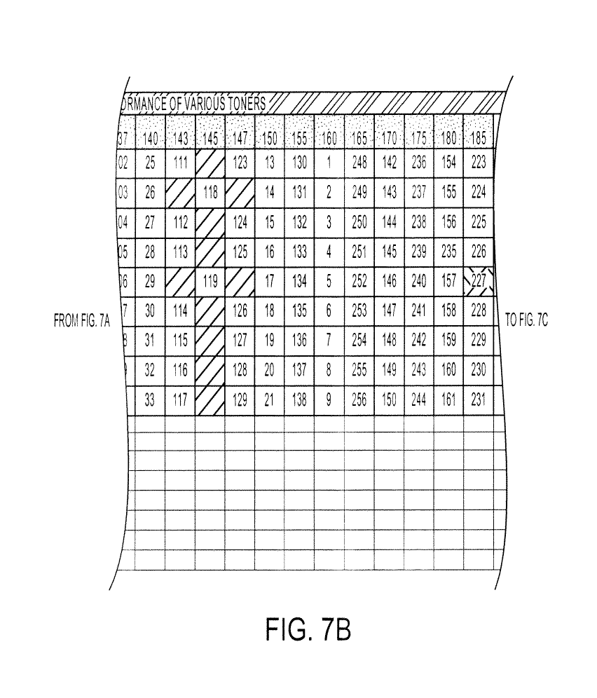

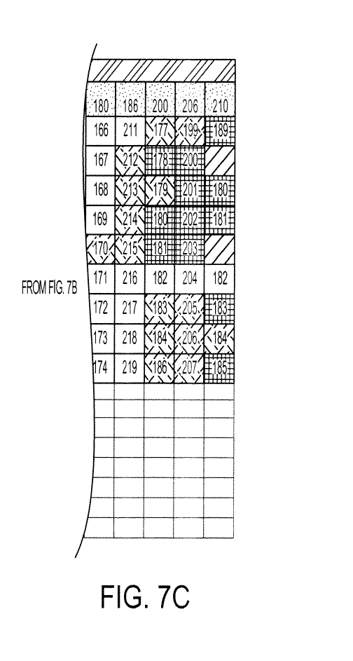

As shown in FIGS. 7A-7C, hot offset (non-stress case) was observed at 210° C. for the Control Toner on CXS paper at 220 mm/s but variations in print gloss (mottle) starting at approximately 200° C. were found. Gloss variations at higher temperatures indicate hot offset temperature is being approached. The onset of gloss mottle started between 190° C. and 200° C. for the low melt samples except for Example Toner 2 which did not appear to show gloss mottle. Two samples (Example Toners 2 and 4) did not hot offset to the fuser roll at 210° C. while the rest of the samples hot offset to the fuser roll between 200° C. and 210° C.

The onset of gloss mottle started between 190° C. and 200° C. for the low melt samples except for Example Toner 2 which did not appear to show gloss mottle. Two samples (Example Toner 2 and Example Toner 4) did not hot offset to the fuser roll at 210° C. while the rest of the samples hot offset to the fuser roll between 200° C. and 210° C.

### CONCLUSION

In summary, the addition of poly(octadecene) into toner particles did not result in further reduction in MFT. In addition, prints for the Example Toners with additive were less glossy than the Control Toner. A summary of the fusing of the Control Toner is provided in Table 5. The fusing results are achieved over many fusing runs and thus demonstrate higher gloss than toner with the polyolefin additive.

TABLE 5

| Control | | | |
|---|---|---|---|
| Toner (EAHG) | CRU 1 | CRU 2 | CRU 3 |
| Fused X Times | 57 | 14 | 22 |
| Substrate | CX+, 90 gsm | CX+, 90 gsm | CXS, 90 gsm |
| TMA (mg/cm²) | 1.05 | 1.05 | 1.05 |
| Average | 62.0 +/− 2.15 | 63.4 +/− 1.26 | 58.8 +/− 1.49 |
| Gloss @ 185° C. | | | |
| Average T (G₄₀) | 157.0 +/− 2.20 | 145.1 +/− 1.61 | 146.6 +/− 1.48 |
| Peak Gloss | | | 59.5 +/− 1.48 |
| Average | 151.4 | 145.1 | 136.1 |
| MFT_{(CA=80)} | | | |
| Std. Dev. for | 2.27 | 1.61 | 1.19 |
| MFT_{(CA=80)} | | | |
| 95% Confidence | 0.60 | 0.93 | 0.53 |
| Level MFT_{(CA=80)} | | | |
| Range in | 146-158 | 143-149 | 134-139 |
| MFT_{(CA=80)} | | | |
| Fracture | | | 1.94 +/− 0.08 |
| Coefficient_{(CA=80)} | | | |

It will be appreciated that several of the above-disclosed and other features and functions, or alternatives thereof, may be desirably combined into many other different systems or applications. Also various presently unforeseen or unanticipated alternatives, modifications, variations or improvements therein may be subsequently made by those skilled in the art, which are also intended to be encompassed by the following claims.

Unless specifically recited in a claim, steps or components of claims should not be implied or imported from the specification or any other claims as to any particular order, number, position, size, shape, angle, color or material.

All references cited herein are herein incorporated by reference in their entireties.

1. A toner composition comprising:
toner particles having a core, wherein the core comprises
a resin,
a colorant,
a wax, and
one or more gloss reducing additives incorporated into the core, the one or more additives comprising a polyolefin being an α-olefin having a carbon number of from about 3 to about 20, wherein the toner composition has tunable gloss.

2. The toner composition of claim 1, wherein the core further comprises one or more of the following: additional colorants, additional waxes, surfactants and residual flocculant.

3. The toner composition of claim 1, wherein the resin is selected from the group consisting of poly(styrene-n-butyl acrylate-(β-CEA), poly(styrene-alkyl acrylate), poly(styrene-1,3-diene), poly(styrene-1,2-diene), poly(styrene-1,4-diene), poly(styrene-alkyl methacrylate), poly(alkyl methacrylate-alkyl acrylate), poly(alkyl methacrylate-aryl acrylate), poly(aryl methacrylate-alkyl acrylate), poly(alkyl methacrylate), poly(styrene-alkyl acrylate-acrylonitrile), poly(styrene-1,3-diene-acrylonitrile), poly(alkyl acrylate-acrylonitrile), poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene); poly(styrene-propyl acrylate), poly(styrene-butyl acrylate), poly(styrene-butadiene-acrylonitrile), poly(styrene-butyl acrylate-acrylonitrile) and mixtures thereof.

4. (canceled)

5. The toner composition of claim 1, wherein the wax is selected from the group consisting of paraffin wax, microcrystalline wax, montan wax, ozokerite wax, ceresin wax, petrolatum wax, petroleum wax, Japan wax, Jojoba wax, beeswax, carnauba wax and mixtures thereof.

6. (canceled)

7. The toner composition of claim 1, wherein the one or more additives are present in an amount of from about 1 to about 50% by weight of the toner particles.

8. The toner composition of claim 7, wherein the one or more additives are present in an amount of from about 1 to about 10% by weight of the toner particles.

9. The toner composition of claim 1, wherein the toner particles comprise the core with a shell disposed over the core, and further wherein the core has a lower glass transition (Tgₒₙ) than the shell.

10. The toner composition of claim 1, wherein the Tgₒₙ of the particle core is from about 0 to about 20 lower than the Tgₒₙ of the particle shell.

11. The toner composition of claim 1, wherein the polyolefin has a weight average molecular weight (Mw) of from about 1,000 to about 1,000,000.

12. The toner composition of claim 1, wherein the polyolefin has a number average molecular weight (Mn) of from about 500 to about 500,000.

13. The toner composition of claim 1, wherein the polyolefin has a polydispersity (PD) of from about 1.0 to about 50.

14. The toner composition of claim 1, wherein the polyolefin has a melting point of from about 40° C. to about 160° C.

15. The toner composition of claim 1 having a gloss level from about 5 to about 90 ggu.

16. The toner composition of claim 1, wherein the more additive is included in the core, the lower a gloss level of the toner composition will be.

17. The toner composition of claim 1 being an emulsion aggregation toner composition.

18. A toner composition comprising:
toner particles having a core, wherein the core comprises
a styrene acrylate resin,
a colorant,
a wax, and
one or more gloss reducing additives incorporated into the core, the one or more additives comprising poly(octadecene), wherein the toner composition has tunable gloss.

19. A developer comprising:
a toner composition; and
a toner carrier, wherein the toner composition comprises
toner particles having a core, wherein the core comprises
a resin,
a colorant,
a wax, and
one or more gloss reducing additives incorporated into the core, the one or more additives comprising a polyolefin being an α-olefin having a carbon number of from about 3 to about 20, wherein the toner composition has tunable gloss.

20. The developer of claim 19, wherein the toner composition is an emulsion aggregation toner composition.
